(19) United States
(12) Patent Application Publication
(10) Pub. No.: US 2026/0172567 A1
(43) Pub. Date: Jun. 18, 2026

(54) METHOD AND APPARATUS FOR ENCODING PICTURE AND DECODING BITSTREAM

(71) Applicant: HUAWEI TECHNOLOGIES CO., LTD., Shenzhen (CN)

(72) Inventors: Elena Alexandrovna Alshina, Munich (DE); Alexander Alexandrovich Karabutov, Munich (DE); Timofey Mikhailovich Solovyev, Munich (DE); Jue Mao, Hangzhou (CN); Yin Zhao, Hangzhou (CN); Yibo Shi, Beijing (CN); Ning Kang, Shenzhen (CN); Jing Wang, Beijing (CN)

(73) Assignee: HUAWEI TECHNOLOGIES CO., LTD., Shenzhen (CN)

(21) Appl. No.: 19/534,478

(22) Filed: Feb. 9, 2026

Related U.S. Application Data
(63) Continuation of application No. PCT/CN2023/112702, filed on Aug. 11, 2023.

(51) Int. Cl. H04N 19/13; H04N 19/124

(52) U.S. Cl. CPC H04N 19/13; H04N 19/124

(57) ABSTRACT

The present disclosure pertains to methods, encoders and decoders for processing a picture in presence of skip algorithm, which allows encoder and decoder based on available for both standard deviation information to skip encoding and decoding insignificant tensor elements. Since elements will not be encoded and decoded due to the skip algorithm, minimal value of standard deviation in arithmetic coder design should be aligned with skip threshold. This reduces size of tables in arithmetic coder and improve coding efficiency.

### CROSS-REFERENCE TO RELATED APPLICATIONS

This application is a continuation of International Application No. PCT/CN2023/112702, filed on Aug. 11, 2023, the disclosure of which is hereby incorporated by reference in its entirety.

### TECHNICAL FIELD

The present disclosure relates to artificial intelligence (AI) coding. In particular, the present disclosure relates to variance quantization in entropy coding.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in picture quality are desirable.

Entropy coding is utilized for encoding and decoding data based on probability distributions, which requires memory to store the probability information. The memory used by the entropy encoder and decoder is proportionally to the number of stored probability distribution information. Lower number of probability distribution information leads to less memory consumed, but may cause coding efficiency drop. How to reduce memory size for storing probability distribution information while achieve higher compression efficiency at the same time is an urgent problem to be solved.

### SUMMARY

The embodiments of the present disclosure provide apparatuses and methods for entropy encoding of data into a bitstream and entropy decoding of data from a bitstream. Embodiments of the present disclosure may allow for reducing memory size for storing probability distribution information and also improving coding efficiency.

One embodiment of the resent disclosure pertains to a method for decoding a bitstream, where the method comprises: obtaining a first bitstream; obtaining a second bitstream, wherein the second bitstream comprises hyper prior information of the first bitstream; obtaining a first sigma tensor based on the second bitstream, wherein the first sigma tensor comprises several sigma values, wherein the sigma values are variance values or standard deviation values, wherein the variance values or the standard deviation values are related with probability distribution information of the first bitstream; obtaining, based on a quantization process, a sigma index for a first sigma value of the first sigma tensor, wherein the sigma index indicates one of probability distributions in a probability distribution table, wherein a minimum sigma value of the quantization process is set equal to a skip threshold, wherein the skip threshold is used in a skip process to obtain a skip mask; entropy decoding, the first bitstream based on the sigma index to obtain a sequence of decoded symbols; processing the sequence of decoded symbols based on the skip mask to obtain a residual tensor, wherein the residual tensor is used to obtain a reconstructed image.

The quantization process quantizes the sigma values as a sigma value among several discrete values between a range of sigma values. The upper boundary of the range is the maximum sigma value σₘₐₓ, the lower boundary of the range is the minimum sigma value σₘᵢₙ, and the number of discrete values is the sigma number N_{σ}.

In other words, the quantized sigma value cannot be less than the minimum sigma value, and cannot be larger than the maximum sigma value.

Entropy coding is utilized for encoding and decoding data based on probability distributions, which requires memory to store the probability information, such as Cumulative Distribution Function (CDF)/Probability Mass Function (PMF) for range coder. Generally, a zero-mean Gaussian distribution is used to encode or decode the latent feature \hat{r}, whose variance comes from the output (σ) of hyper scale decoder. The variance is quantized into a finite number of quantized sigma values. Each quantized sigma value indicates a particular distribution described by pre-defined tables. These tables are used from time to time during entropy coding, so these tables are typically stored in Read Only Memory (ROM) of an ASIC codec or L1 data cache (typically 32 KB per core for CPUs) of a software codec. Smaller table size is helpful to reduce the cost of ASIC design as well as to reduce cache miss in software codec. However, lower number of sampled distributions may lead to loss in the compression efficiency due to using less accurate probability in entropy coding.

The memory used by the entropy encoder and decoder (e.g., CDF/PMF tables in the range coder) is proportionally to the number of the quantized sigma values from the hyper scale decoder. Lower number of quantization levels leads to less memory consumed, but may cause coding efficiency drop. The present application proposal optimized the sigma (variance) quantization method to reduce the number of quantization levels and save entropy coding related table size and achieve higher coding efficiency.

Skip is widely used for improving throughput of arithmetic coder. Skip logic results in not encoding some elements with variance/standard deviation lower than skip threshold. One can understand that if σ″ comming from the Entropy Decoder is wrong (such as too small), the skip process will be disabled based on a cube_flag. If the skip process is enabled, due to Skip process, all residual elements with σ″<(threshold_skip) will not be coded and will be set to 0, which means Sigma_Idx for σ″<(threshold_skip) is never used. Thus, if the σₘᵢₙ is set to be less than (threshold_skip), sigma_index for σ″ between the σₘᵢₙ and the (threshold_skip) will never be used, which causes codec resources wasting and coding efficiency reducing, and especially leads to improperly occupy of the memory resources. Thus, the present application proposes that the σₘᵢₙ which is the minimum of the variance/standard deviation in the sigma quantization process is modified to be equal to the threshold_skip in the Skip logic (such as the threshold used in the Skip Mask process). In one specific embodiment, σₘᵢₙ=(threshold_skip). In one specific embodiment, the threshold_skip is set as a default value 0.2 (which is equivalent to value 382 in integerized implementation), as a result, the σₘᵢₙ can be modified as 0.2. If the threshold_skip is set as other default value, the σₘᵢₙ should be modified to be equal to the default value of the threshold_skip, the 0 min in the prior art is equal to 0.11, the modified σₘᵢₙ is large than the prior art value 0.11. Thus, on the one hand, the sigma_index table size will be reduced, which reduces memory consumed; on the other hand, if the skip process is disabled by the cube_flag, which indicates that the sigma (variance) is wrongly set to too small value, then σₘᵢₙ is used.

Furthermore, the present application proposes that the table size/the number of the quantized variances/the number of quantization levels/the number of probability distributions (N_{σ}) has been set as power of 2. In one specific embodiment, N, is equal to 2⁵=32. N_{σ} in the prior art is equal to 35, the modified N_{σ} is less than 35, as a result, the modification is helpful to reduce memory consumed and achieve simpler search for variance index.

Besides, the present application proposes that the σₘₐₓ which is maximum variance/standard deviation value in sigma quantization process is modified as a value in the range of 30 to 64, in one specific embodiment, the σₘₐₓ is set to be equal to 30, the σₘₐₓ in the prior art is equal to 100, the modified σₘₐₓ is less than the prior art value 100. Thus, the bitstream size can be reduced without changing the quality or effecting the coding efficiency, and dynamic range in Entropy will be reduced.

In one embodiment, the skip mask is used to indicate which elements of a second tensor are present in the second bitstream, where the second tensor is based on the value of sigma derived from the first sigma tensor.

One can understand that some elements of the second sigma tensor are skipped based on the sigma mask.

In one embodiment, the minimum sigma value of the quantization process is set equal to 0.2.

In one embodiment, the minimum sigma value of the quantization process is set equal to threshold_skip, wherein the threshold_skip indicates the skip threshold.

In one embodiment, a maximum sigma value of the quantization process is set equal to a value in a range of 30 to 64.

In one embodiment, a maximum sigma value of the quantization process is set equal to 30.

In one embodiment, the quantization process quantizes a sigma value in the first sigma tensor into a sigma value among several discrete values in a range from the minimum sigma value to the maximum sigma value.

In one embodiment, a sigma number of the quantization process is set as a power of 2, wherein the sigma number indicates the number of the probability distributions in the probability distribution table.

In one embodiment, a sigma number of the quantization process is set as a power of 2, the sigma number indicates the number of the discrete values in the range.

In one embodiment, the sigma number of the quantization process is set equal to 32.

In one embodiment, the obtaining the first sigma tensor based on the second bitstream comprises: entropy decoding the second bitstream to obtain a decoded hyper-prior tensor; processing, based on a hyper scale decoder, the decoded hyper-prior tensor to obtain a second sigma tensor; scaling the second sigma tensor to obtain the first sigma tensor.

In one embodiment, the output of the hyper scale decoder is a log domain sigma tensor, the first sigma tensor is a scaled log domain sigma tensor.

In one embodiment, wherein the first sigma value is a linear domain standard deviation value or a linear domain variance value.

In one embodiment, the skip mask indicates determines which samples of the sequence of the decoded symbols are included in the bitstream. All of the other samples of the sequence of the decoded symbols are inferred to be equal to zero.

In one embodiment, the first sigma tensor comprises the sigma values or the standard deviation values in logarithmic domain.

In one embodiment, the first sigma value is a logarithmic domain standard deviation value or a logarithmic domain variance values.

In one embodiment, the input of the sigma quantization process is standard deviation values in linear of logarithmic domain, or in other words, the input of the sigma quantization process is log-domain standard deviation tensor I″_{σ}. And the sigma quantization process convert the log-domain standard deviation tensor to a sigma index.

In one embodiment, the obtaining, based on the quantization process, the sigma index for the first sigma value comprises:
obtaining the sigma index based on the following equation:

$$sigma\_Idx = clip ( ( {I}_{σ}^{″} + {2}^{sigmaPrecision - 1} ) ≫ sigmaPrecision , 0 , {N}_{σ} - 1 ) .$$

wherein the sigma_idx represents the sigma index, the I_{σ}″ represents the first sigma value in the logarithmic domain, or the I_{σ}″ represents the standard deviation value in the logarithmic domain, the sigmaPrecision is equal to 7, the N_{σ} is equal to 32.

In one embodiment, where the obtaining, based on the quantization process, the sigma index for the first sigma value comprises:
obtaining the sigma index based on the following equation:

$$sigma\_Idx = i , {b}_{i} \leq {σ}^{″} < {b}_{i + 1}$$

$${b}_{i} = exp ( ( ln ( {σ}_{max} ) - ln ( {σ}_{min} ) ) \cdot ( i + 0.5 ) / ( {N}_{σ} - 1 ) + ln ( {σ}_{min} ) )$$

$$i = 0 , … , {N}_{σ} - 1$$

wherein the sigma_idx represents the sigma index, the σ″ represents the first sigma value in a linear domain, the σₘᵢₙ is the minimum sigma value, the σₘₐₓ is the maximum sigma value, the N_{σ} is the sigma number.

In one embodiment, the N_{σ} is equal to 32.

In one embodiment, the σₘᵢₙ is equal to 0.2.

In one embodiment, σₘₐₓ is a value in a range of 30 to 64.

One embodiment of the present application discloses a method for encoding a bitstream, wherein the method comprises: obtaining hyper prior information of an image data; obtaining a first sigma tensor based on the hyper prior information, wherein the first sigma tensor comprises several sigma values, where the sigma values are variance values or standard deviation values, wherein the sigma values are variance values related with probability distribution information of the image data; obtaining, based on a quantization process, a sigma index for a first sigma value of the first sigma tensor, wherein the sigma index indicates one of probability distributions in a probability distribution table, wherein a minimum sigma value of the quantization process is set equal to a skip threshold, wherein the skip threshold is used in a skip process to obtain a skip mask; processing a sequence of symbols based on the skip mask to obtain a sequence of encoded symbols; entropy encoding the sequence of encoded symbols based on the sigma index to obtain a first bitstream.

In one embodiment, the skip mask is used to indicate which elements of a second tensor are present in the second bitstream, where the second tensor is based on the value of sigma derived from the first sigma tensor.

In one embodiment, the minimum sigma value of the quantization process is set equal to 0.2.

In one embodiment the minimum sigma value of the quantization process is set equal to threshold_skip, wherein the threshold_skip indicates the skip threshold.

In one embodiment, a maximum sigma value of the quantization process is set equal to a value in a range of 30 to 64.

In one embodiment, a maximum sigma value of the quantization process is set equal to 30.

In one embodiment, the quantization process quantizes a sigma value in the first sigma tensor into a sigma value among several discrete values in a sigma range from the minimum sigma value to the maximum sigma value.

In one embodiment, a sigma number of the quantization process is set as a power of 2, wherein the sigma number indicates the number of the probability distributions in the probability distribution table.

In one embodiment, a sigma number of the quantization process is set as a power of 2, the sigma number indicates the number of the discrete values in the range.

In one embodiment, the sigma number of the quantization process is set equal to 32.

In one embodiment, the first sigma tensor comprises the sigma values or the standard deviation values in logarithmic domain.

In one embodiment, the output of the hyper scale decoder is a log domain sigma tensor, the first sigma tensor is a scaled log domain sigma tensor.

In one embodiment, the skip mask indicates which samples of the sequence of the decoded symbols are included in the bitstream. All of the other samples of the sequence of the decoded symbols are inferred to be equal to zero.

In one embodiment, where the first sigma value is a logarithmic domain standard deviation value or a logarithmic domain variance value.

In one embodiment, where the first sigma value is a linear domain standard deviation value or a linear domain variance value.

In one embodiment, the input of the sigma quantization process is standard deviation values in linear of logarithmic domain, or in other words, the input of the sigma quantization process is log-domain standard deviation tensor I″_{σ}. And the sigma quantization process convert the log-domain standard deviation tensor to a sigma index.

In one embodiment, the obtaining, based on the quantization process, the sigma index for the first sigma value comprises:
obtaining the sigma index based on the following equation:

$$sigma\_Idx = clip ( ( {I}_{σ}^{″} + {2}^{sigmaPrecision - 1} ) ≫ sigmaPrecision , 0 , {N}_{σ} - 1 ) .$$

wherein the sigma_idx represents the sigma index, the I_{σ}″ represents the first sigma value in the logarithmic domain, the sigmaPrecision is equal to 7, the N_{σ} is equal to 32.

In one embodiment, where the obtaining, based on the quantization process, the sigma index for the first sigma value comprises:
obtaining the sigma index based on the following equation:

$$sigma\_Idx = i , {b}_{i} \leq {σ}^{″} < {b}_{i + 1}$$

$${b}_{i} = exp ( ( ln ( {σ}_{max} ) - ln ( {σ}_{min} ) ) \cdot ( i + 0.5 ) / ( {N}_{σ} - 1 ) + ln ( {σ}_{min} ) )$$

$$i = 0 , … , {N}_{σ} - 1$$

wherein the sigma_idx represents the sigma index, the σ″ represents the first sigma value in a linear domain, the σₘᵢₙ is the minimum sigma value, the σₘₐₓ is the maximum sigma value, the N_{σ} is the sigma number.

In one embodiment, the N_{σ} is equal to 32.

In one embodiment, the σₘᵢₙ is equal to 0.2.

In one embodiment, σₘₐₓ is a value in a range of 30 to 64.

One embodiment of the present application discloses a decoder for processing a bitstream, comprising a storage medium and one or more processors, wherein the storage medium is configured to store computer executable instructions, the one or more processors are configured to perform a method according to wherein the encoder is adapted to perform a method according to any one of the forgoing embodiments.

One embodiment of the present application discloses an encoder for processing a bitstream, comprising a storage medium and one or more processors, wherein the storage medium is configured to store computer executable instructions, the one or more processors are configured to perform a method according to any one of the forgoing embodiments.

One embodiment of the present application discloses a computer-readable storage medium comprising computer executable instructions that, when executed on a computer or a processor, cause the computer or the processor to execute a method according to any one of the forgoing embodiments.

One embodiment of the present application discloses an encoder for encoding a picture, wherein the encoder comprises a receiver for receiving a picture, a transmitter for outputting a bitstream and one or more processors configured to implement the method according to any one of the forgoing embodiments.

One embodiment of the present application discloses a decoder for decoding a bitstream representing a picture, wherein the decoder comprises a receiver for receiving a first bitstream and a second bitstream, a transmitter for outputting a decoded picture and one or more processors configured to implement the method according to any one of the forgoing embodiments.

An embodiment of the present application discloses a computer program product comprising computer executable instructions that, when executed on a computing system, cause the computing system to execute a method according to any one of the forgoing embodiments.

One embodiment of the present application discloses a computer program stored on a storage medium, wherein computer program comprises computer executable instructions that, when executed on a computer or a processor, cause the computer or the processor to execute a method according to any one of the forgoing embodiments.

Moreover, a computer-readable storage medium is provided that stores computer executable instructions that, when executed on a computing system, cause the computing system to execute a method according to any of the above embodiments.

### BRIEF DESCRIPTION OF THE DRAWINGS

FIG. 1A is a block diagram showing an example of a video coding system configured to implement an embodiments of the present disclosure;

FIG. 1B is a block diagram showing another example of a video coding system configured to implement some embodiments of the present disclosure;

FIG. 2 is a block diagram illustrating an example of an encoding apparatus or a decoding apparatus;

FIG. 3 is a block diagram illustrating another example of an encoding apparatus or a decoding apparatus;

FIG. 4 shows an encoder and a decoder together according to one embodiment;

FIG. 5 shows a schematic depiction of encoding and decoding of an input;

FIG. 6 shows an encoder and a decoder in line with a VAE framework;

FIG. 7 shows components of an encoder according to FIG. 4 in accordance with one embodiment;

FIG. 8 shows components of a decoder according to FIG. 4 in accordance with one embodiment;

FIG. 9 shows an example of JPEG AI encoder architecture;

FIG. 10 shows an example of JPEG AI decoder structure;

FIG. 11 shows an example of decoder structure for one component;

FIG. 12 shows an example illustrating hyper scale decoder;

FIG. 13 shows an example illustrating synthesis transform net;

FIG. 14 shows an example of a decoder structure;

FIG. 15 shows an example of an encoder structure;

FIG. 16 shows a flow diagram of a method for decoding a bitstream according to one embodiment;

FIG. 17 shows a flow diagram of a method for encoding a bitstream according to one embodiment;

FIG. 18 shows an exemplary block diagram of a decoder structure;

FIG. 19 shows an exemplary block diagram of an encoder structure;

FIG. 20 shows an exemplary block diagram of a decoder structure;

FIG. 21 shows an exemplary block diagram of an encoder structure;

FIG. 22A shows a schematic depiction of Residual activation unit;

FIG. 22B shows a schematic depiction of Residual activation function;

FIG. 22C shows a schematic depiction of Residual non-local attention block (RBAN);

FIG. 22D shows a schematic depiction of Residual block (RB);

FIG. 22E shows a schematic depiction of Lightweight residual block (LRB).

### DETAILED DESCRIPTION

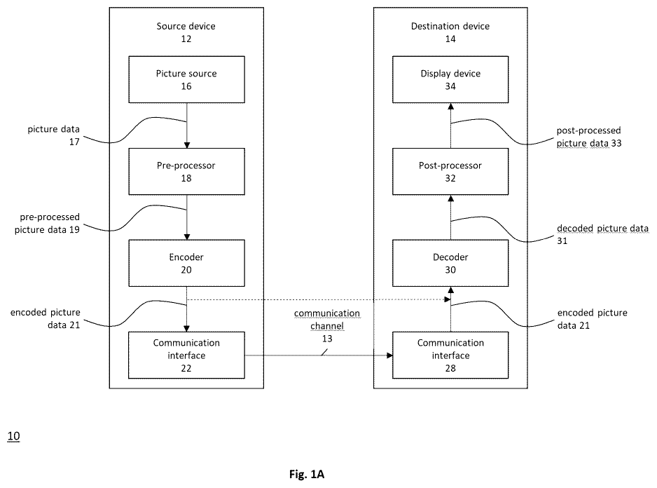

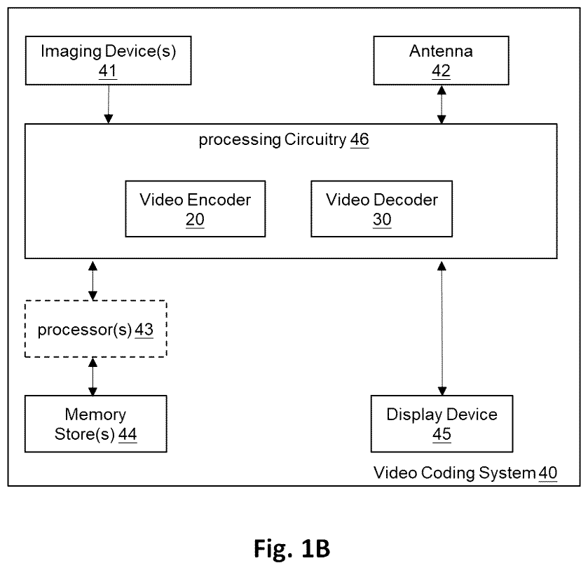

In the following, some embodiments are described with reference to the Figs. The FIGS. 1A to 3 refer to video coding systems and methods that may be used together with more specific embodiments of the application described in the further Figs. Specifically, the embodiments described in relation to FIGS. 1A to 3 may be used with encoding/decoding techniques described further below that make use of a neural network for encoding a bitstream and/or decoding a bitstream.

In the following description, reference is made to the accompanying Figs., which form part of the disclosure, and which show, by way of illustration, specific aspects of the present disclosure or specific aspects in which embodiments of the present disclosure may be used. It is understood that the embodiments may be used in other aspects and comprise structural or logical changes not depicted in the Figs. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method operations are described, a corresponding device may include one or a plurality of units, e.g. functional units, to perform the described one or plurality of method operations (e.g. one unit performing the one or plurality of operations, or a plurality of units each performing one or more of the plurality of operations), even if such one or more units are not explicitly described or illustrated in the Figs. On the other hand, for example, if a specific apparatus is described based on one or a plurality of units, e.g. functional units, a corresponding method may include one operation to perform the functionality of the one or plurality of units (e.g. one operation performing the functionality of the one or plurality of units, or a plurality of operations each performing the functionality of one or more of the plurality of units), even if such one or plurality of operations are not explicitly described or illustrated in the Figs. Further, it is understood that the features of the various exemplary embodiments and/or aspects described herein may be combined with each other, unless specifically noted otherwise.

Video coding typically refers to the processing of a sequence of pictures, which form the video or video sequence. Instead of the term “picture” the term “frame” or “image” may be used as synonyms in the field of video coding. Video coding (or coding in general) comprises two parts video encoding and video decoding. Video encoding is performed at the source side, typically comprising processing (e.g. by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general) shall be understood to relate to “encoding” or “decoding” of video pictures or respective video sequences. The combination of the encoding part and the decoding part is also referred to as CODEC (Coding and Decoding).

In case of lossless video coding, the original video pictures can be reconstructed, i.e. the reconstructed video pictures have the same quality as the original video pictures (assuming no transmission loss or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

Several video coding standards belong to the group of “lossy hybrid video codecs” (i.e. combine spatial and temporal prediction in the sample domain and 2D transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. by using spatial (intra picture) prediction and/or temporal (inter picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g. intra- and inter predictions) and/or re-constructions for processing, i.e. coding, the subsequent blocks. Recently, some parts or the entire encoding and decoding chain has been implemented by using a neural network or, in general, any machine learning or deep learning framework.

In the following embodiments of a video coding system 10, a video encoder 20 and a video decoder 30 are described.

FIG. 1A is a schematic block diagram illustrating an example coding system 10, e.g. a video coding system 10 (or short coding system 10) that may utilize techniques of this present application. Video encoder 20 (or short encoder 20) and video decoder 30 (or short decoder 30) of video coding system 10 represent examples of devices that may be configured to perform techniques in accordance with various examples described in the present application.

As shown in FIG. 1A, the coding system 10 comprises a source device 12 configured to provide encoded picture data 21 e.g. to a destination device 14 for decoding the encoded picture data 13.

The source device 12 comprises an encoder 20, and may additionally comprise a picture source 16, a pre-processor (or pre-processing unit) 18, e.g. a picture pre-processor 18, and a communication interface or communication unit 22. Some embodiments of the present disclosure (e.g. relating to an initial rescaling or rescaling between two proceeding layers) may be implemented by the encoder 20. Some embodiments (e.g. relating to an initial rescaling) may be implemented by the picture pre-processor 18.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 1A pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

The decoder 30 is configured to receive the encoded picture data 21 and provide decoded picture data 31 or a decoded picture 31 (further details will be described below, e.g., based on FIG. 3).

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

Some embodiments of the disclosure may be implemented by the decoder 30 or by the post-processor 32.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 1A depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 1A may vary depending on the actual device and application.

The encoder 20 (e.g. a video encoder 20) or the decoder 30 (e.g. a video decoder 30) or both encoder 20 and decoder 30 may be implemented via processing circuitry as shown in FIG. 1B, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody various modules and/or any other encoder system or subsystem described herein. The decoder 30 may be implemented via processing circuitry 46 to embody various modules and/or any other decoder system or subsystem described herein. The processing circuitry may be configured to perform the various operations as discussed later. As shown in FIG. 3, if the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 1B.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 1A is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

For convenience of description, some embodiments are described herein, for example, by reference to High-Efficiency Video Coding (HEVC) or to the reference software of Versatile Video coding (VVC), the next generation video coding standard developed by the Joint Collaboration Team on Video Coding (JCT-VC) of ITU-T Video Coding Experts Group (VCEG) and ISO/IEC Motion Picture Experts Group (MPEG). One of ordinary skill in the art will understand that embodiments of the application are not limited to HEVC or VVC.

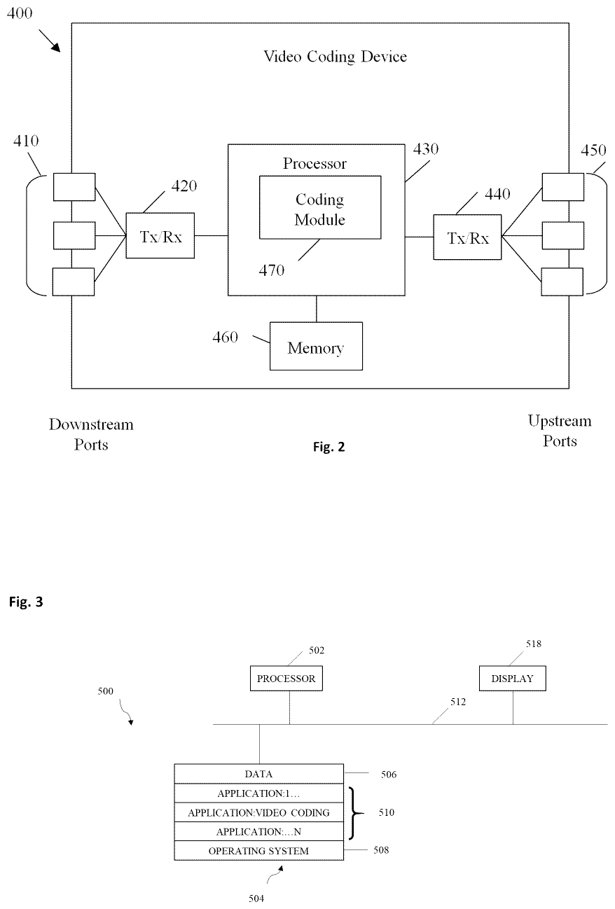

FIG. 2 is a schematic diagram of a video coding device 400 according to an embodiment of the disclosure. The video coding device 400 is suitable for implementing the disclosed embodiments as described herein. In an embodiment, the video coding device 400 may be a decoder such as video decoder 30 of FIG. 1A or an encoder such as video encoder 20 of FIG. 1A.

The video coding device 400 comprises ingress ports 410 (or input ports 410) and receiver units (Rx) 420 for receiving data; a processor, logic unit, or central processing unit (CPU) 430 to process the data; transmitter units (Tx) 440 and egress ports 450 (or output ports 450) for transmitting the data; and a memory 460 for storing the data. The video coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals.

The processor 430 is implemented by hardware and software. The processor 430 may be implemented as one or more CPU chips, cores (e.g., as a multi-core processor), FPGAs, ASICs, and DSPs. The processor 430 is in communication with the ingress ports 410, receiver units 420, transmitter units 440, egress ports 450, and memory 460. The processor 430 comprises a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 may comprise one or more disks, tape drives, and solid-state drives and may be used as an over-flow data storage device, to store programs when such programs are selected for execution, and to store instructions and data that are read during program execution. The memory 460 may be, for example, volatile and/or non-volatile and may be a read-only memory (ROM), random access memory (RAM), ternary content-addressable memory (TCAM), and/or static random-access memory (SRAM).

FIG. 3 is a simplified block diagram of an apparatus 500 that may be used as either or both of the source device 12 and the destination device 14 from FIG. 1 according to an exemplary embodiment.

A processor 502 in the apparatus 500 can be a central processing unit. Alternatively, the processor 502 can be any other type of device, or multiple devices, capable of manipulating or processing information now-existing or hereafter developed. Although the disclosed embodiments can be practiced with a single processor as shown, e.g., the processor 502, advantages in speed and efficiency can be achieved using more than one processor.

A memory 504 in the apparatus 500 can be a read only memory (ROM) device or a random access memory (RAM) device in an embodiment. Any other suitable type of storage device can be used as the memory 504. The memory 504 can include code and data 506 that is accessed by the processor 502 using a bus 512. The memory 504 can further include an operating system 508 and application programs 510, the application programs 510 including at least one program that permits the processor 502 to perform the methods described here. For example, the application programs 510 can include applications 1 through N, which further include a video coding application that performs the methods described here.

The apparatus 500 can also include one or more output devices, such as a display 518. The display 518 may be, in one example, a touch sensitive display that combines a display with a touch sensitive element that is operable to sense touch inputs. The display 518 can be coupled to the processor 502 via the bus 512.

Although depicted here as a single bus, the bus 512 of the apparatus 500 can be composed of multiple buses. Further, the secondary storage 514 can be directly coupled to the other components of the apparatus 500 or can be accessed via a network and can comprise a single integrated unit such as a memory card or multiple units such as multiple memory cards. The apparatus 500 can thus be implemented in a wide variety of configurations.

In the following, more specific, non-limiting, and exemplary embodiments of the application are described. Before that, some explanations will be provided aiding in the understanding of the disclosure:

Artificial neural networks (ANN) or connectionist systems are computing systems vaguely inspired by the biological neural networks that constitute animal brains. An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it. In ANN embodiments, the “signal” at a connection is a real number, and the output of each neuron can be computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision.

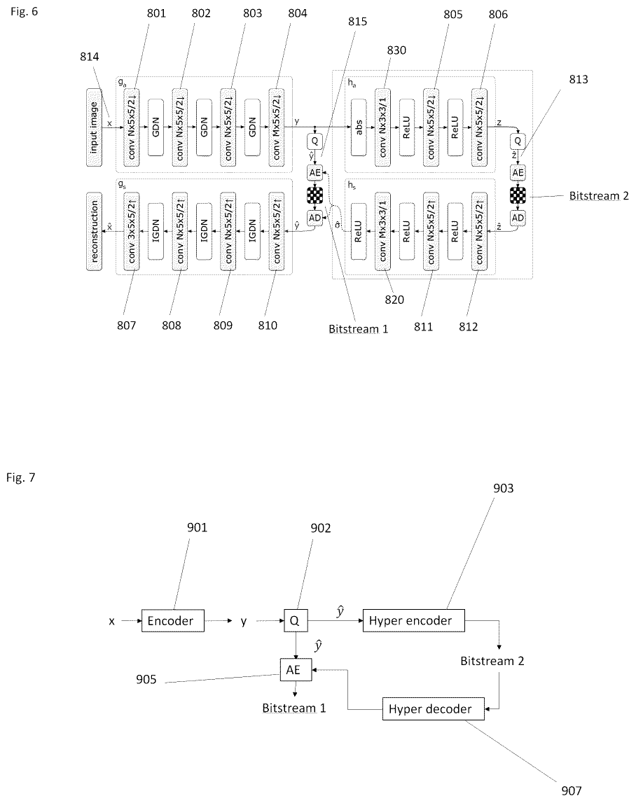

The name “convolutional neural network” (CNN) indicates that the network employs a mathematical operation called convolution. Convolution is a specialized kind of linear operation. Convolutional networks are simply neural networks that use convolution in place of general matrix multiplication in at least one of their layers. A convolutional neural network consists of an input and an output layer, as well as multiple hidden layers. Input layer is the layer to which the input is provided for processing. For example, the neural network of FIG. 6 is a CNN. The hidden layers of a CNN typically consist of a series of convolutional layers that convolve with a multiplication or other dot product. The result of a layer is one or more feature maps, sometimes also referred to as channels. There may be a subsampling involved in some or all of the layers. As a consequence, the feature maps may become smaller. The activation function in a CNN may be a RELU (Rectified Linear Unit) layer or a GDN layer as already exemplified above, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how weight is determined at a specific index point.

When programming a CNN for processing pictures or images, the input is a tensor with shape (number of images)×(image width)×(image height)×(image depth). Then, after passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns. CNN models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear down-sampling. There are several non-linear functions to implement pooling among which max pooling is the most common. It partitions the input image into a set of non-overlapping rectangles and, for each such sub-region, outputs the maximum. Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

An autoencoder is a type of artificial neural network used to learn efficient data codings in an unsupervised manner. The aim of an autoencoder is to learn a representation (encoding) for a set of data, typically for dimensionality reduction, by training the network to ignore signal “noise”. Along with the reduction side, a reconstructing side is learnt, where the autoencoder tries to generate from the reduced encoding a representation as close as possible to its original input, hence its name.

Picture size: refers to the width or height or the width-height pair of a picture. Width and height of an image is usually measured in number of luma samples.

Downsampling: Downsampling is a process, where the sampling rate (sampling interval) of the discrete input signal is reduced. For example if the input signal is an image which has a size of height h and width w (or H and Was referred to below likewise), and the output of the downsampling is a height h2 and a width w2, at least one of the following holds true:

$$h 2 < h$$

$$w 2 < w$$

In one embodiment, downsampling can be implemented as keeping only each m-th sample, discarding the rest of the input signal (which, in the context of the application, basically is a picture).

Upsampling: Upsampling is a process, where the sampling rate (sampling interval) of the discrete input signal is increased. For example if the input image has a size of h and w (or H and Was referred to below likewise), and the output of the downsampling is h2 and w2, at least one of the following holds true:

$$h < h 2$$

$$w < w 2$$

Resampling: downsampling and upsampling processes are both examples of resampling. Resampling is a process where the sampling rate (sampling interval) of the input signal is changed.

Interpolation filtering: During the upsampling or downsampling processes, filtering can be applied to improve the accuracy of the resampled signal and to reduce the aliasing affect. An interpolation filter usually includes a weighted combination of sample values at sample positions around the resampling position. It can be implemented as:

$$f ( {x}_{r} , {y}_{r} ) = \sum s ( x , y ) C ( k )$$

Where f( ) is the resampled signal, (xᵣ, yᵣ) are the resampling coordinates, C(k) are interpolation filter coefficients and s(x,y) are or is the input signal. The summation operation is performed for (x,y) that are in the vicinity of (xᵣ, yᵣ).

Cropping: Trimming off the outside edges of a digital image. Cropping can be used to make an image smaller (in number of samples) and/or to change the aspect ratio (length to width) of the image.

Padding: padding refers to increasing the size of the input image (or image) by generating new samples at the borders of the image. This can be done, for example, by either using sample values that are predefined or by using sample values of the positions in the input image.

Resizing: Resizing is a general term where the size of the input image is changed. It might be done using one of the methods of padding or cropping. It can be done by a resizing operation using interpolation. In the following, resizing may also be referred to as rescaling.

Integer division: Integer division is division in which the fractional part (remainder) is discarded.

Convolution: convolution is given by the following general equation. Below f( ) can be defined as the input signal and g( ) can be defined as the filter.

$$( f * g ) [ n ] = {\sum }_{m = - ∞}^{∞} f [ m ] g [ n - m ]$$

Downsampling layer: A processing layer, such as a layer of a neural network that results in a reduction of at least one of the dimensions of the input. In general, the input might have 3 or more dimensions, where the dimensions might comprise number of channels, width and height. However, the present disclosure is not limited to such signals. Rather, signals which may have one or two dimensions (such as audio signal or an audio signal with a plurality of channels) may be processed. The downsampling layer usually refers to reduction of the width and/or height dimensions. It can be implemented with convolution, averaging, max-pooling etc. operations. Also other ways of downsampling are possible and the application is not limited in this regard.

Upsampling layer: A processing layer, such as a layer of a neural network that results in an increase of one of the dimensions of the input. In general, the input might have 3 or more dimensions, where the dimensions might comprise number of channels, width and height. The upsampling layer usually refers to increase in the width and/or height dimensions. It can be implemented with de-convolution, replication etc. operations. Also, other ways of upsampling are possible and the application is not limited in this regard.

Some deep learning based image and video compression algorithms follow the Variational Auto-Encoder framework (VAE), e.g. G-VAE: A Continuously Variable Rate Deep Image Compression Framework, (Ze Cui, Jing Wang, Bo Bai, Tiansheng Guo, Yihui Feng), available at: https://arxiv.org/abs/2003.02012.

The VAE framework could be counted as a nonlinear transforming coding model.

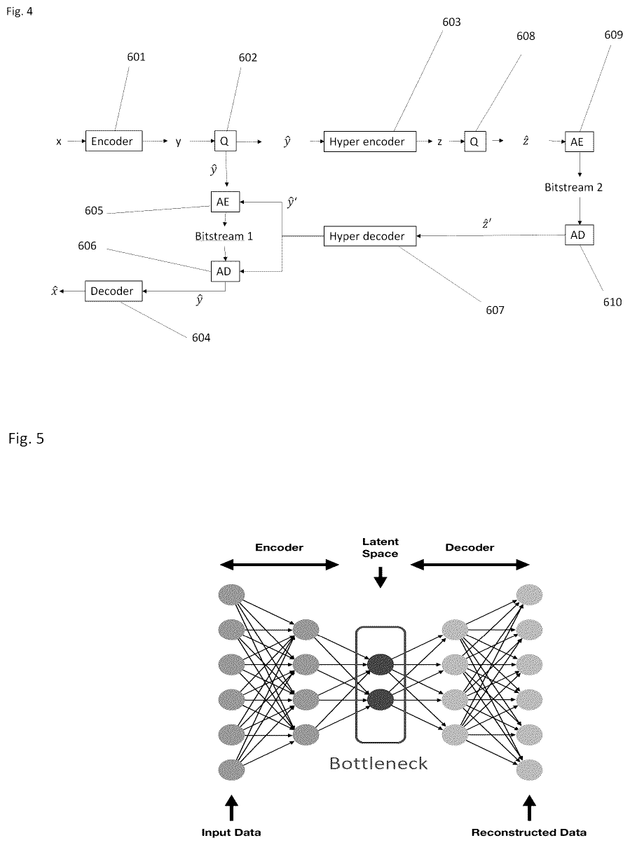

The transforming process can be mainly divided into four parts: FIG. 4 exemplifies the VAE framework. In the FIG. 4, the encoder 601 maps an input image x into a latent representation (denoted by y) via the function y=f(x). This latent representation may also be referred to as a part of or a point within a “latent space” in the following. The function f( ) is a transformation function that converts the input signal x into a more compressible representation y. The quantizer 602 transforms the latent representation y into the quantized latent representation ŷ with (discrete) values by ŷ=Q(y), with Q representing the quantizer function. The entropy model, or the hyper encoder/decoder (also known as hyperprior) 603 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis.

The quantized latent representation T, ŷ and the side information \hat{z} of the hyperprior 3 are included into a bitstream 2 (are binarized) using arithmetic coding (AE).

Furthermore, a decoder 604 is provided that transforms the quantized latent representation to the reconstructed image \hat{x}, \hat{x}=g(ŷ). The signal \hat{x} is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes bitstream1 and bitstream2 shown in FIG. 4, which are generated by the encoder and transmitted to the decoder. Normally, the higher the amount of side information, the higher the reconstruction quality. However, a high amount of side information means that the compression ratio is low. Therefore, one purpose of the system described in FIG. 4 is to balance the reconstruction quality and the amount of side information conveyed in the bitstream.

In FIG. 4 the component AE 605 is the Arithmetic Encoding module, which converts samples of the quantized latent representation ŷ and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 606 is the process of reverting the binarization process, where binary digits are converted back to sample values. The arithmetic decoding is provided by the arithmetic decoding module 606.

It is noted that the present disclosure is not limited to this particular framework. Moreover the present disclosure is not restricted to image or video compression, and can be applied to object detection, image generation, and recognition systems as well.

In FIG. 4 there are two sub networks concatenated to each other. A subnetwork in this context is a logical division between the parts of the total network. For example in the FIG. 4 the modules 601, 602, 604, 605 and 606 are called the “Encoder/Decoder” subnetwork. The “Encoder/Decoder” subnetwork is responsible for encoding (generating) and decoding (parsing) of the first bitstream “bitstream1”. The second network in FIG. 4 comprises modules 603, 608, 609, 610 and 607 and is called “hyper encoder/decoder” subnetwork. The second subnetwork is responsible for generating the second bitstream “bitstream2”. The purposes of the two subnetworks are different. The first subnetwork is responsible for:
the transformation 601 of the input image x into its latent representation y (which is easier to compress that x),
quantizing 602 the latent representation y into a quantized latent representation ŷ,
compressing the quantized latent representation ŷ using the AE by the arithmetic encoding module 605 to obtain bitstream “bitstream 1”,”.
Parsing the bitstream 1 via AD using the arithmetic decoding module 606, and
reconstructing 604 the reconstructed image (\hat{x}) using the parsed data.

The purpose of the second subnetwork is to obtain statistical properties (e.g. mean value, variance and correlations between samples of bitstream 1) of the samples of “bitstream1”, such that the compressing of bitstream 1 by first subnetwork is more efficient. The second subnetwork generates a second bitstream “bitstream2”, which comprises the said information (e.g. mean value, variance and correlations between samples of bitstream1).

The second network includes an encoding part which comprises transforming 603 of the quantized latent representation ŷ into side information z, quantizing the side information z into quantized side information \hat{z}, and encoding (e.g. binarizing) 609 the quantized side information \hat{z} into bitstream2. In this example, the binarization is performed by an arithmetic encoding (AE). A decoding part of the second network includes arithmetic decoding (AD) 610, which transforms the input bitstream2 into decoded quantized side information \hat{z}′. The \hat{z}′ might be identical to \hat{z}, since the arithmetic encoding and decoding operations are lossless compression methods. The decoded quantized side information \hat{z}′ is then transformed 607 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 605 and Arithmetic Decoder 606 to control the probability model of ŷ.

The FIG. 4 describes an example of VAE (variational auto encoder), details of which might be different in different embodiments. For example, in an embodiment, additional components might be present to more efficiently obtain the statistical properties of the samples of bitstream 1. In one embodiment, a context modeler may be present, which targets extracting cross-correlation information of the bitstream 1. The statistical information provided by the second subnetwork might be used by AE (arithmetic encoder) 605 and AD (arithmetic decoder) 606 components.

The FIG. 4 depicts the encoder and decoder in a single figure. As is clear to those skilled in the art, the encoder and the decoder may be, and very often are, embedded in mutually different devices.

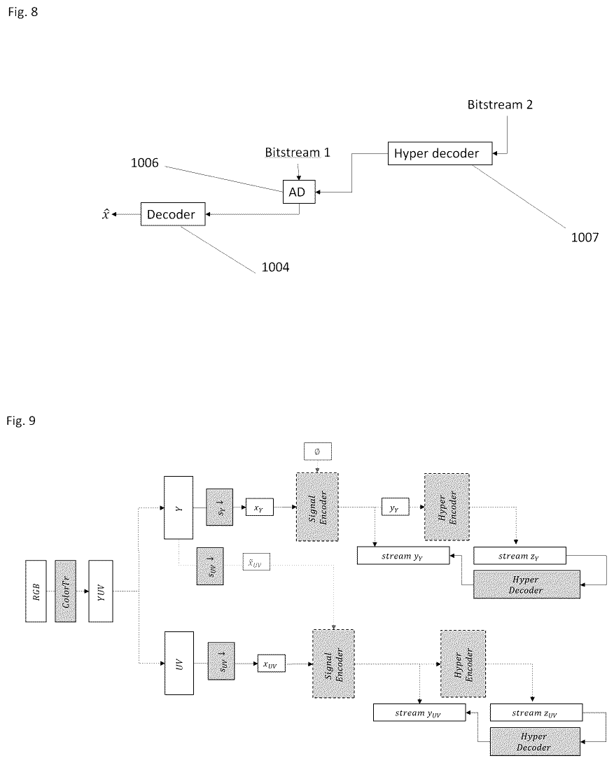

FIG. 7 depicts the encoder and FIG. 8 depicts the decoder components of the VAE framework in isolation.

As input, the encoder receives, according to some embodiments, a picture. The input picture may include one or more channels, such as color channels or other kind of channels, e.g. depth channel or motion information channel, or the like. The output of the encoder (as shown in FIG. 7) is a bitstream1 and a bitstream2. The bitstream1 is the output of the first sub-network of the encoder and the bitstream2 is the output of the second subnetwork of the encoder.

Similarly in FIG. 8, the two bitstreams, bitstream1 and bitstream2, are received as input and \hat{z}, which is the reconstructed (decoded) image, is generated at the output.

As indicated above, the VAE can be split into different logical units that perform different actions. This is exemplified in FIGS. 7 and 8 so that FIG. 7 depicts components that participate in the encoding of a signal, like a video and provided encoded information. This encoded information is then received by the decoder components depicted in FIG. 8 for encoding, for example. It is noted that the components of the encoder and decoder denoted with numerals 9xx and 10xx may correspond in their function to the components referred to above in FIG. 4 and denoted with numerals 6xx.

Specifically, as is seen in FIG. 7, the encoder comprises the encoder 901 that transforms an input x into a signal y which is then provided to the quantizer 902. The quantizer 902 provides information to the arithmetic encoding module 905 and the hyper encoder 903. The hyper encoder 903 provides the bitstream2 already discussed above to the hyper decoder 907 that in turn signals information to the arithmetic encoding module 605.

The encoding can make use of a convolution. Decoding can make use of a de-convolution.

The output of the arithmetic encoding module is the bitstream1. The bitstream1 and bitstream2 are the output of the encoding of the signal, which are then provided (transmitted) to the decoding process.

Although the unit 901 is called “encoder”, it is also possible to call the complete subnetwork described in FIG. 7 as “encoder”. The process of encoding in general means the unit (module) that converts an input to an encoded (e.g. compressed) output. It can be seen from FIG. 7, that the unit 901 can be actually considered as a core of the whole subnetwork, since it performs the conversion of the input x into y, which is the compressed version of the x. The compression in the encoder 901 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 901 by a lossy compression. The AE 905 in combination with the hyper encoder 903 and hyper decoder 907 used to configure the AE 905 may perform the binarization which may further compress the quantized signal by a lossless compression. Therefore, it is also possible to call the whole subnetwork in FIG. 7 an “encoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some embodiments may provide an encoder which reduces size only in one (or in general a subset of) dimension.

The general principle of compression is exemplified in FIG. 5. The latent space, which is the output of the encoder and input of the decoder, represents the compressed data. It is noted that the size of the latent space may be much smaller than the input signal size. Here, the term size may refer to resolution, e.g. to a number of samples of the feature map(s) output by the encoder. The resolution may be given as a product of number of samples per each dimension (e.g. width×heighth×number of channels of an input image or of a feature map).

The reduction in the size of the input signal is exemplified in the FIG. 5, which represents a deep-learning based encoder and decoder. In the FIG. 5, the input image x corresponds to the input Data, which is the input of the encoder. The transformed signal y corresponds to the Latent Space, which has a smaller dimensionality or size in at least one dimension than the input signal. Each column of circles represent a layer in the processing chain of the encoder or decoder. The number of circles in each layer indicate the size or the dimensionality of the signal at that layer.

One can see from the FIG. 5 that the encoding operation corresponds to a reduction in the size of the input signal, whereas the decoding operation corresponds to a reconstruction of the original size of the image.

One of the methods for reduction of the signal size is downsampling. Downsampling is a process where the sampling rate of the input signal is reduced. For example if the input image has a size of h and w, and the output of the downsampling is h2 and w2, at least one of the following holds true:

$$h 2 < h$$

$$w 2 < w$$

The reduction in the signal size usually happens step by step along the chain of processing layers, not all at once. For example if the input image x has dimensions (or size of dimensions) of h and w (indicating the height and the width), and the latent space y has dimensions h/16 and w/16, the reduction of size might happen at 4 layers during the encoding, wherein each layer reduces the size of the signal by a factor of 2 in each dimension.

Some deep learning based video/image compression methods employ multiple downsampling layers. As an example the VAE framework, FIG. 6, utilizes 6 downsampling layers that are marked with 801 to 806. The layers that include downsampling is indicated with the downward arrow in the layer description. The layer description “Conv N×5×5/2↓” means that the layer is a convolution layer, with N channels and the convolution kernel is 5×5 in size. As stated, the 2↓ means that a downsampling with a factor of 2 is performed in this layer. Downsampling by a factor of 2 results in one of the dimensions of the input signal being reduced by half at the output. In FIG. 6, the 2↓ indicates that both width and height of the input image is reduced by a factor of 2. Since there are 6 downsampling layers, if the width and height of the input image 814 (also denoted with x) is given by w and h, the output signal \hat{z} 813 has width and height equal to w/64 and h/64 respectively. Modules denoted by AE and AD are arithmetic encoder and arithmetic decoder, which are explained above already with respect to FIGS. 4, 7 and 8. The arithmetic encoder and decoder are embodiments of entropy coding. AE and AD (as part of the component 813 and 815) can be replaced by other means of entropy coding. In information theory, an entropy encoding is a lossless data compression scheme that is used to convert the values of a symbol into a binary representation which is a revertible process. Also the “Q” in the figure corresponds to the quantization operation that was also referred to above in relation to FIG. 4 and is further explained above in the section “Quantization”. Also, the quantization operation and a corresponding quantization unit as part of the component 813 or 815 is not necessarily present and/or can be replaced with another unit.

In FIG. 6, there is also shown the decoder comprising upsampling layers 807 to 812. A further layer 820 is provided between the upsampling layers 811 and 810 in the processing order of an input that is implemented as convolutional layer but does not provide an upsampling to the input received. A corresponding convolutional layer 830 is also shown for the decoder. Such layers can be provided in NNs for performing operations on the input that do not alter the size of the input but change specific characteristics. However, it is not necessary that such a layer is provided.

When seen in the processing order of bitstream2 through the decoder, the upsampling layers are run through in reverse order, i.e. from upsampling layer 812 to upsampling layer 807. Each upsampling layer is shown here to provide an upsampling with an upsampling ratio of 2, which is indicated by the f. It is, of course, not necessarily the case that all upsampling layers have the same upsampling ratio and also other upsampling ratios like 3, 4, 8 or the like may be used. The layers 807 to 812 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (801 to 803) are followed by generalized divisive normalization (GDN) at the encoder side and by the inverse GDN (IGDN) at the decoder side. In the second subnetwork, the activation function applied is ReLu. It is noted that the present disclosure is not limited to such embodiment and in general, other activation functions may be used instead of GDN or ReLu.

The image and video compression systems in general cannot process arbitrary input image sizes. The reason is that some of the processing units (such as transform unit, or motion compensation unit) in a compression system operate on a smallest unit, and if the input image size is not integer multiple of the smallest processing unit, it is not possible to process the image.

As an example, HEVC specifies four transform units (TUs) sizes of 4×4, 8×8, 16×16, and 32×32 to code the prediction residual. Since the smallest transform unit size is 4×4, it is not possible to process an input image that has a size of 3×3 using an HEVC encoder and decoder. Similarly if the image or picture size is not a multiple of 4 in one dimension, it is also not possible to process the image or picture, respectively, since it is not possible to partition the image or picture into sizes that are processable by the valid transform units (4×4, 8×8, 16×16, and 32×32). Therefore, it is a requirement of the HEVC standard that the input image or picture must be a multiple of a minimum coding unit size, which is 8×8. Otherwise the input image or picture is not compressible by HEVC. Similar requirements have been posed by other codecs, too. In order to make use of existing hardware or software, or in order to maintain some interoperability or even portions of the existing codecs, it may be desirable to maintain such limitation. However, the present disclosure is not limited to any particular transform block size.

Some DNN (deep neural network) or NN (neural network) based image and video compression systems utilize multiple downsampling layers. In FIG. 6, for example, four downsampling layers are comprised in the first subnetwork (layers 801 to 804) and two additional downsampling layers are comprised in the second subnetwork (layers 805 to 806). Therefore, if the size of the input image is given by w and h respectively (indicating the width and the height), the output of the first subnetwork is w/16 and h/16, and the output of the second network is given by w/64 and h/64.

The term “deep” in deep neural networks usually refers to the number of processing layers that are applied sequentially to the input. When the number of the layers is high, the neural network is called a deep neural network, though there is no clear description or guidance on which networks should be called a deep network. Therefore for the purposes of this application there is no major difference between a DNN and an NN. DNN may refer to a NN with more than one layer.

During downsampling, for example in the case of convolutions being applied to the input, fractional (final) sizes for the encoded picture can be obtained in some cases. Such fractional sizes cannot be reasonably processed by a subsequent layer of the neural network or by a decoder.

Entropy coding is utilized for encoding and decoding data based on probability distributions, which requires memory to store the probability information, such as Cumulative Distribution Function (CDF)/Probability Mass Function (PMF) for range coder. Generally, a zero-mean Gaussian distribution is used to encode or decode the latent feature \hat{r}, whose variance comes from the output (σ) of hyper scale decoder. The variance is quantized into a finite number of quantized sigma values. Each quantized sigma value indicates a particular distribution described by pre-defined tables. These tables are used from time to time during entropy coding, so these tables are typically stored in Read Only Memory (ROM) of an ASIC codec or L1 data cache (typically 32 KB per core for CPUs) of a software codec. Smaller table size is helpful to reduce the cost of ASIC design as well as to reduce cache miss in software codec. However, lower number of sampled distributions may lead to loss in the compression efficiency due to using less accurate probability in entropy coding.

Generally, two parameters control the way of variance quantization: quantization center (Sampling) and quantization intervals (or called as quantization boundary). In one example, quantization center σ_{idx} of the variance σ follows a power-law form, as described by the following equation:

$${σ}_{idx} = s ( idx ) = exp ( ( ln ( {σ}_{max} ) - ln ( {σ}_{min} ) ) * \frac{idx}{L} + ln ( {σ}_{min} ) ) , idx ∈ [ 0 , L )$$

where L=64, σₘᵢₙ=0.11, σₘₐₓ=256, and L indicates the number of quantized variances, denoted as the number of quantization levels, that is, 64 probability distributions need to be stored, denoted as [symbol] ={σ₀, σ₁, . . . , σ₆₃}. After that, the continuous variance value σ[c, i, j] generated from Hyper Scale Decoder is quantized, by which the values in interval (σₖ₋₁, θₖ] will be quantized as σₖ.

The memory used by the entropy encoder and decoder (e.g., CDF/PMF tables in the range coder) is proportionally to the number of the quantized sigma values from the hyper scale decoder. Lower number of quantization levels leads to less memory consumed, but may cause coding efficiency drop. The present application proposal optimized the sigma (variance) quantization method to reduce the number of quantization levels and save entropy coding related table size and achieve higher coding efficiency.

Skip is widely used for improving throughput of arithmetic coder. Skip logic results in not encoding some elements with variance/standard deviation lower than skip threshold. In this application an equation for variance/standard deviation quantize is modified to be aligned with skip logic. To be specific, the min variance/standard deviation value in quantizing equation is equal to skip threshold. Additionally the max variance/standard deviation value in quantizing equation is reduced, to reduced dynamic range in entropy decoder. Furthermore, the table size (N_{σ}) has been set as power of 2 to achieve simpler search for variance index. An instantiation of the JPEG AI image encoder architecture is presented in FIG. 9. Encoder splits colours using colour transform (denoted as “colorTr” on FIG. 9) to primary component denoted as “Y” and secondary component denoted as “UV” (which essentially combination for two non-primary colour planes of the image). Each component is re-sampled using it's own scale factor (down-sampling modules are denotes as “s \”) and encoded separately using modules consisting of same sequence of same neural-network layers, with the only difference in sizes on input tensors and number of tensor channels.

Data (tensors and streams) are shown inside the “white” boxes, neural network modules necessary for encoding and decoding are shown in grey shadowed boxes. Dash border of the box and dash arrows indicate encoder only operation.

The codestream is composed from bit-streams stream z and stream y for primary and secondary components.

FIG. 10 shows an example of JPEG AI decoder structure. Data (tensors and streams) are shown inside the “white” boxes, neural network modules necessary for decoding are shown in grey shadowed boxes. For primary and secondary colour components code streams can be parsed independently and reconstructed using modules consisting of same sequence of same neural-network layers, with the only difference in sizes on input tensors and number of tensor channels. Single component decoder is shown in FIG. 11.

First stream z shall be parsed by loss-less entropy decoder, for example the entropy decoder can be a me-tANS decoder. The probability distribution for loss-less coding of \hat{z} is assumed to be Gaussian with pre-trained parameters (part of the trained model), Commulative Distribution Function (denoted on a FIG. 11 as CDF(\hat{z})) computed based on those pre-trained parameters is used in loss-less entropy decoder.

Decoded hyper-prior tensors \hat{z} is used as an input for two different processes: Hyper Decoder and Hyper Scale Decoder.

Then stream y shall be parsed by loss-less decoder (such as a me-tANS decoder). The probability distribution for parsing \hat{r} is assumed to be Gaussian with zero mean value and standard deviation given as an output if following operations: Hyper Scale Decoder outputs tensors σ[C, h₄, w₄] or log domain standar deviation tensor log σ, then it is scalled according to the rate control parameter β inside Sigma Scale to produce σ′ or log domain standar deviation tensor log σ′, and then masked and scalled according to RVS parameters section inside Adaptive Sigma Scale producing σ″ or log domain standar deviation tensor log σ″. Finally tensor σ″ values or log domain standar deviation tensor log σ″ are quantized inside the Sigma quantization process, in this Sigma quantization process, the tensor σ″ values or or log domain standar deviation tensor log σ″. are converted to the index of probability distribution table. According to the rules, specified by SKIP Mode some elements of residual tensor are skipped (not encoded/decoded) and replaced by zeros in Decoder SKIP module, which recives parsed set of syntax elements {s} from tANS Decoder, mask_sigma from SKIP Mask generation module and outputs re-shaped to 3D shape reconstructed residual tensor \hat{r}[C, h₄, w₄]. In one embodiment, the outputs and inputs of the Hyper Scale Decoder, the Sigma Scale, the Adaptive Sigma Scale are all log domain tensors,

At decoder side the residual \hat{r} is scaled by Inverse Gain Unit according to the parameter β, producing \hat{r}′. Then residual tensor is scaled in inv RVS (Inverse Residual and Variance Scale) module forming residual tensor \hat{r}″. This is used for reconstructed latent tensor ŷ.

As shown on FIG. 10 after reconstruction primary and secondary components re-sampled (up-sampling module is denoted as “s↑” on FIG. 10) each with it's own scaling factor. After re-sampling to original picture size all three colour components go through Inter Channel Correlation Information (ICCI) filter. The ICCI filter provides enhancement of colour information planes (secondary components) of image utilising information from brightness (primary component).

The input of this ICCI filter process is
\hat{x}′_{Y}[1, H, W] (after re-sampling module denoted as “s_{Y}↑” in FIG. 10),
\hat{x}′_{UV}[2, H, W] (after re-sampling module denoted as “s_{UV}↑” in FIG. 10),
trained ICCI model parameters according to icci_model_idx for each colour component (0,1,2).

The output of this process is
full size enhanced [symbol] [3, H, W] (YUV in FIG. 10).

Reconstruction process is concluded by inverse colour transform (“invColorTr” on FIG. 10), the input of the inverse colour transform process are three colour planes Ŷ[H, W], Û[H, W], \hat{V}[H, W]. The output of this process is reconstructed image in a form of three colour plane tensor [symbol] [3, H, W]. The inverse colour transform in performed for each pixel with coordinates [i, j], 0≤i<H, 0≤j<W.

One should understand that the hyper encoder, the hyper decoder and the hyper scale decoder all consist of two independent pipe-lines for primary and secondary components.

The decoder operations of me-tANS entropy decoder is described, the input of the me-tANS decoder is
bitstream (one of “stream—y_{Y}”, “stream—y_{UV}”, “stream—z_{Y}” or “stream—z_{UV}”)

The output of this process
sequence of symbols {s}, which later goes through SKIP mode decoder process (for residual tensor) or simply re-shaped to 3D tensor to be re-shaped \hat{z}.

The hyper encoder is described, the input of hyper encoder includes:
y[C, h₄, w₄] latent tensor,
sizes of input/output tensor Hᵢₙ, Wᵢₙ
operation point indicator opIdx,
model parameters for Hyper Encoder Net defined by (modelIdx)

The output of hyper encoder is hyper tensor z of size [C, h₆, w₆].

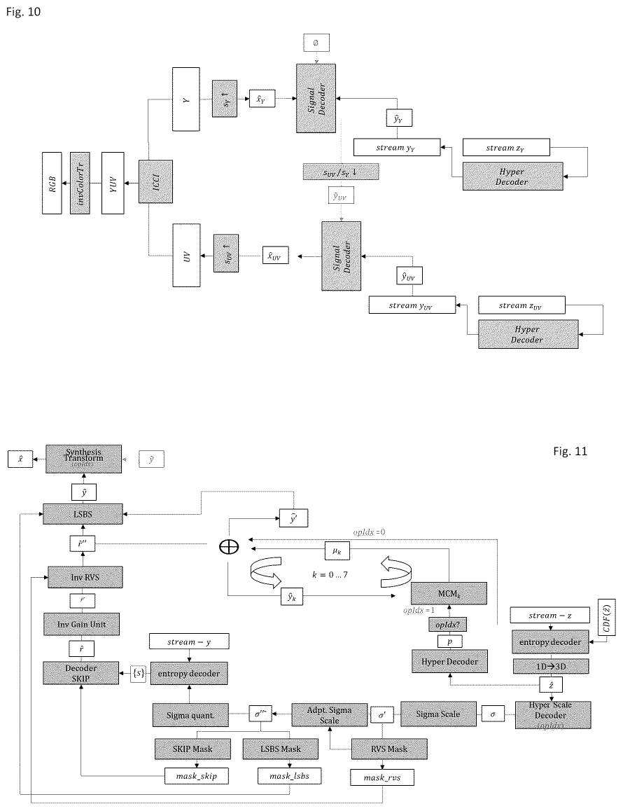

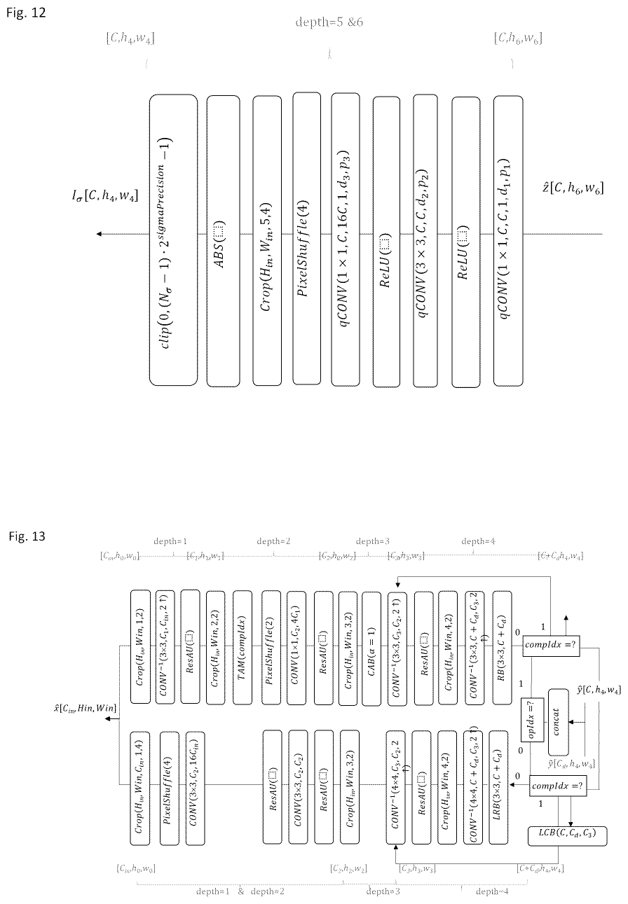

An example of hyper scale decoder is shown in FIG. 12.

The input of hyper scale decoder includes:
\hat{z}[C, h₆, w₆] reconstructed hyper tensor,
sizes of input/output tensor Hᵢₙ, Wᵢₙ
operation point indicator opIdx,
model parameters for Hyper Scale Decoder Net defined by pair (modelIdx, opIdx), all multiplier parameters in those models are 8-bits integer.

The output of hyper scale decoder is standard deviation logarithm tensor I_{σ}[C, h₄, w₄] with integer values in a range 0≤I_{σ}<((N_{σ}−1)<<sigmaPrecision), where N_{σ}=32, sigmaPrecision=7.

One can understandard that the output of the hyper scale decoder is log domain standard deviation tensor, the log domain is an abbreviation of logarithmic domain.

All operation in scalable hyper decoder are integer, an accumulator in all computations is within 32 bits integer diapason, model parameters are quantized to 8-bits integer. This guarantees bit-exact behaviour of this neural network module. Hyper scale decoder uses special type of operations quantized convolutions and quantized transposed convolution. For each quantized convolution in the process the set of clipping values {dₖ} and de-scaling shifts parameters {pₖ} is specified (1≤k≤(opIdx=0)? 4:5). All clipping values in quantized convolutions are dₖ=2¹⁵−1. De-scaling shifts {pₖ} are part of trained model.

NOTE—the magnitude of ingested weights in quantized model doesn't exceed 2¹⁵−1, shift and clipping value combination ensures the register of quantized convolution is within 32-bits.

Depending on operation point indicator (opIdx) hyper scale decoder performs following sequence of operations.

In hyper scale decoder for base operating point (opIdx=0) the number of channels is C for all hidden layers. Hyper scale decoder starts with quantized transposed convolution kernel size 4×4, stride 2, followed by cropping layer (stride 2, depth 6) and rectified linear unit. Then there is a stride 1 quantized convolution with kernel size 3×3, followed by rectified linear unit. The again quantized transposed convolution kernel size 4×4, stride 2, followed by cropping layer (stride 2, depth 5) and rectified linear unit, and a stride 1 quantized convolution with kernel size 3×3.

For high operating point (opIdx=1) two sets of stride 1 quantized convolution with kernel size 3×3 increase number of channels to 4C, followed by pixel shuffle (stride 2), which brings number of channels back to C, cropping layer (stride 2, depth 6 and 5 correspondently), concluded rectified linear unit. channels C. Then there are three stride 1 quantized convolution with kernel size 3×3, two of those are followed by rectified linear unit.

The Sigma Scale in FIG. 11 is described, the sigma scale is applied both at encoder and decoder sides, the input of the sigma scale includes:
forward gain vector m;
standard deviation tensor σ of size [C, h₄, w₄], which is and output of Hyper Scale Decoder (D.3).

The output of the sigma scale process:
scaled by forward gain vector standard deviation tensor σ′ of size [C, h₄, w₄], which goes to the adaptive sigma scale.

Sigma scale modifies standard deviation tensor σ[C, h₄, w₄] as an input and output standard deviation tensor multiplied by gain vector:

$${σ}^{′} [ c , i , j ] = m [ c ] \cdot σ [ c , i , j ] ;$$

$$i = 0 , … , {h}_{4} - 1 , j = 0 , … {w}_{4} - 1 , c = 0 , … , C - 1.$$

All elements of the tensor in the same channel are scaled by the same multiplier.

The adaptive sigma scale (showed as “Adpt. Sigma Scale” in FIG. 11) is applied both at encoder and decode sides, the adaptive sigma scale process is enabled adaptively based on value num_rvs_params, if num_rvs_params==1.

The input of the adaptive sigma scale process includes:

| | |
|---|---|
| - | num_rvs_params; |
| - | mask_rvs[num_rvs_params, C, h₄, w₄]; |
| - | presice_flag_rvs [num_rvs_params]; |
| - | scale_rvs [num_rvs_params]; |
| - | standard deviation tensor σ′[C, h₄, w₄] |
| | or log-domian standard deviation tensor |
| | I′_{σ}[C, h₄, w₄] after Sigma Scale. |

The output of this process is
scaled residual tensor σ″[C, h₄, w₄] or log-domain scaled residual tensor I″_{σ}[C, h₄, w₄].

The process of Adaptive Sigma Scale is as follows:
First σ″ tensors is initialized to be equal to σ′
For idx=0 . . . num_rvs_params−1 the following ordered operations are applied:
   De-scaling parameters are set as shift=(precise_flag_rvs[idx]==1)?=13:7 and offset=(2\hat{ }shift)−1
   Each element of the scaled residual tensor \tilde{σ} is obtained as follows:

$${σ}^{″} [ c , i , j ] = \{ \begin{matrix}( {σ}^{″} [ c , i , j ] \cdot scale\_rvs [ idx ] + offsett ) ≫ shift , & if mask\_rvs [ idx ] [ c , i , j ] is True , \\ \tilde{σ} [ c , i , j ] & overwise\end{matrix}$$

In case num_rvs_params=0 inverse sigma scale process is essentially disabled and output tensor \tilde{σ} identical to the input σ′.

In one embodiment, control parameters and gain vector derivation is described as follows:

In total five models are trained for different range of quality. Model is selected base on modelIdx coded at Picture header. Rate control parameter β controls compression ratio and defines operations in Sigma Scale, Inverse and Forward Gain Unit.

The forward gain vector m is used at encoder side in Gain Unit. Forward gain vector in logarithmic scale m_{log} is used in Sigma scale. The inverse gain vector m⁻¹ is used at decoder side in Inverse Gain Unit. Both forward m and inverse m⁻¹ gain vectors have size [C] equal to the number of channels of residual tensor.

Learnable model includes reference forward gain vector in logarithmic scale

$${m}_{log}^{t}$$

for five models t=0, . . . , 4. Elements of vector

$${m}_{log}^{t}$$

are 12 bit values.

The input of gain vector derivation process is
12-bits variable betaDisplacementLog equal to betaDisplacementLogY for primary and to betaDisplacementLogUV for secondary component;
modelIdx which indicates learnable model to be used;
reference forward gain vector m^{t}_{log} for t=modelIdx.

The output of gain vector derivation process is
forward gain vector in logarithmic scale m_{log};
forward gain vector m;
inverse gain vector m⁻¹.

Forward gain vector in logarithmic scale m_{log} is computed as following:

m_{log}=m^{t}_{log}+betaDisplacementLog

Forward and backward gain vectors m and m⁻¹ are computed as following:

$$stepSize = \frac{( ln ( {σ}_{max} ) - ln ( {σ}_{min} ) )}{{N}_{σ} - 1}$$

$$m = exp ( \frac{{m}_{log} \cdot stepSize}{{2}^{sigmaPrecision}} )$$

$${m}^{- 1} = \frac{1}{m} ,$$

where σₘᵢₙ=0.2; σₘₐₓ=30; N_{σ}=32, sigmaPrecision=7.

In one embodiment, the Sigma quantization (Sigma quant. in the FIG. 11) process is described as follows:

The input of this Sigma quantization process includes:
σ_log″[C, h₄, w₄] or be denoted as I″_{σ}[C, h₄, w₄] which is an output Adaptive Sigma Scale.

The output of this process includes:
sigma_Idx[C, h₄, w₄] which is further used in Entropy Decoder for \hat{r}.

The Sigma quantization process is as follows.

$$For c = 0 , … , C - 1 , i = 0 , … , {h}_{4} - 1 , j = 0 , … {w}_{4} - 1$$

sigma_Idx[c,i,j]=clip((I″_{σ}[c,i,j]+2^{sigmaPrecision-1})>>sigmaPrecision,0,N_{σ}−1),

where N_{σ}=32, sigmaPrecision=7.

While computing CDF table for sigma_Idx=i, i∈[0, N_{σ}), it is assumed that

$${σ}_{i} = exp ( ( ln ( {σ}_{max} ) - ln ( {σ}_{min} ) ) \cdot i / {N}_{σ} + ln ( {σ}_{min} ) ) ,$$

where σₘᵢₙ=0.2, σₘₐₓ=30.

Entropy coding is utilized for encoding and decoding data based on probability distributions, which requires memory to store the probability information, such as Cumulative Distribution Function (CDF)/Probability Mass Function (PMF) table for range coder. Generally, a zero-mean Gaussian distribution is used to encode or decode the latent feature f, whose variance comes from the output (o) of hyper scale decoder. The variance is quantized into a finite number of quantized sigma values. Each quantized sigma value indicates a particular distribution described by pre-defined tables. These tables are used from time to time during entropy coding. N_{σ} indicates the number of probability distributions stored in the memory (or the table size) for entropying encoding and decoding. Each of the probability distributions has a variance (denoted as σ), σₘᵢₙ indicates the minimum variance of the stored probability distributions, and σₘₐₓ indicates the maxmum of the variance of the stored probability distributions. The sigma_Idx is used to indicate an index of a probability distribution used by the entropy decoder/encoder.

In an embodiment, σₘᵢₙ indicates the minimum of the variance/standard deviation in the sigma quantization procss, σₘₐₓ indicates the maxmum of the variance/standard deviation in the sigma quantization procss, N_{σ} indicates the number of probability distribution tables stored in the memory for entropying encoding and decoding.

In one embodiment, the probability distribution for parsing \hat{r} is assumed to be Gaussian with zero mean value and standard deviation in log-domain as an output if following operations: Hyper Scale Decoder outputs tensors idx[C, h₄, w₄], then it is scalled according to the rate control parameter β inside Sigma Scale to produce idx′, and then masked and scalled according to RVS parameters section inside Adaptive Sigma Scale producing idx″.

Skip process is widely used for improving throughput of arithmetic coder. Skip logic results in not encoding some elements with variance/standard deviation lower than skip threshold. One can understand that if σ″ comming from the Entropy Decoder is wrong (such as too small), the skip process will be disabled based on a cube_flag. If the skip process is enabled, due to Skip process, all residual elements with σ″<(threshold_skip) will not be coded and will be set to 0, which means Sigma_Idx for σ″<(threshold_skip) is never used. Thus, if the σₘᵢₙ is set to be less than (threshold_skip), sigma_index for σ″ between the σₘᵢₙ and the (threshold_skip) will never be used, which causes codec resources wasting and coding efficiency reducing, and especially leads to improperly occupy of the memory resources.

Thus, the present application proposes that the σₘᵢₙ which is the minimum of the variance/standard deviation in the sigma quantization procss is modified to be equal to the threshold_skip in the Skip logic (such as the threshold used in the Skip Mask process). In one specific embodiment, σₘᵢₙ=(threshold_skip<<shift). In one specific embodiment, the threshold_skip is set as a default value 0.2, as a result, the σₘᵢₙ can be modified as 0.2. If the threshold_skip is set as other default value, the σₘᵢₙ should be modified to be equal to the default value of the threshold_skip, the σₘᵢₙ in the prior art is equal to 0.11, the modified σₘᵢₙ is large than the prior art value 0.11. Thus, on the one hand, the sigma_index table size will be reduced, which reduces memory consumed; on the other hand, if the skip process is disabled by the cube_flag, which indicates that the sigma (variance) is wrongly set to too small value, then σₘᵢₙ is used.

Furthermore, the present application proposes that the table size/the number of the quantized variances/the number of quantization levels/the number of probability distributions (N_{σ}) has been set as power of 2. In one specific embodiment, N_{σ} is equal to 2⁵=32. N_{σ} in the prior art is equal to 35, the modified N_{σ} is less than 35, as a result, the modification is helpful to reduce memory consumed and achieve simpler search for variance index.

Besides, the present application proposes that the σₘₐₓ which is maximum variance/standard deviation value in sigma quantization procss is modified as a value in the range of 30 to 64, in a specific embodiment, the σₘₐₓ is set to be 30. The σₘₐₓ in the prior art is equal to 100, the modified max is less than the prior art value 100. Thus, the bitstream size can be reduced without changing the quality or effecting the coding efficiency, and dynamic range in Entropy will be reduced.

In another embodiment, the Sigma quantization (Sigma quant. in the FIG. 11) process is described as follows:

The input of this Sigma quantization process is
σ″[C, h₄, w₄] which is an output Adaptive Sigma Scale.

The output of this process is
sigma_Idx[C, h₄, w₄] which is further used in Entropy Decoder for f.

The set of values {bᵢ}, i=0, . . . , N_{σ}−1 is computed as follows:

$${b}_{i} = exp ( ( ln ( {σ}_{max} ) - ln ( {σ}_{min} ) ) \cdot ( i + 0.5 ) / {N}_{σ} + ln ( {σ}_{min} ) ) ,$$

where σₘᵢₙ=0.20, σₘₐₓ=30 . . . 64, N_{σ}=32.

The process is as follows.

$$For c = 0 , … , C - 1 , i = 0 , … , {h}_{4} - 1 , j = 0 , … {w}_{4} - 1$$

$$sigma\_Idx [ c , i , j ] = i - 1 , if \tilde{σ} [ c , i , j ] ∈ ( {b}_{i - 1} , {b}_{i} ] .$$

While computing CDF table for sigma_Idx=i, i∈[0, N_{σ}), it is assumed that

$${σ}_{i} = exp ( ( ln ( {σ}_{max} ) - ln ( {σ}_{min} ) ) \cdot i / {N}_{σ} + ln ( {σ}_{min} ) )$$

Where, bᵢ indicates quantization boundary, σᵢ indicates quantization center, the continuous variance value is quantized, by which the values in interval (σᵢ₋₁, σᵢ] will be quantized as σᵢ. And the sigma_idx will be equal to i−1.

The latent space prediction process is described as follows:

Prediction μ is a tensor of same size as latent tensor y[C, h₄, w₄]. At encoder side prediction is subtracted from latent tensor producing residual tensor r[C, h₄, w₄], which is rounded to integer (int 16) and encoded by me-tANS entropy coder. At decoder size prediction is added to the decoder residual producing reconstructed tensor ŷ[C, h₄, w₄].

The Hyper Decoder in FIG. 11 is described, the learning-based hyper decoder consists of two independent pipe-lines with identical neural network architecture, except input size and number of channels.

The input of this hyper decoder process is
\hat{z}[C, h₆, w₆] reconstructed hyper latent tensor,
model parameters for Hyper Decoder Net defined by (modelIdx).

The output of this process is
p[2C, h₄, w₄] is explicit prediction (part of predicton tensor derived from explicitly signalled information).

Hyper decoder generates explicit_prediction input to Multi-stage Context Model—MCM, which is eight stages neural network process, which also takes reconstructed residual \hat{r}″ as an input and outputs latent space tensors ŷ′. After Latent Scaling Before Synthesis-LSBS reconstructed latent space tensor ŷ is ready for signal reconstruction. Latent tensors reconstructions for primary and secondary components are independent from each other.

The Residual and Variance Scale (RVS) is described as follows:

The RVS module scales both the residual and the standard deviation parameter used to create the entropy coding model. RVS works together and share the same scaling factors. The position of residual scaling is after Gain Unit on encoder side. The position of inverse residual scaling is right after inverse Gain Unit. Adaptive Sigma Scale scaling is located after Sigma Scale module. The process of RVS achieves adaptive quantization of residual samples based on their corresponding standard deviation value.

The RVS scaling tensor generation process is described as follows:

The input of RVS scaling tensor generation process includes:
log-domian standard deviation tensor I′_{σ}[C, h₄, w₄] after Sigma Scale.
rvs_num_idx

The output of RVS Mask generation process
scaling_rvs[C, h₄, w₄].

Variables used in this section are defined as follows:
threshold_rvs;
scale_rvs;
num_rvs_params is equal to 3 if rvs_num_idx is 1; otherwise, num_rvs_params is equal to 1.
Process Conversion of standard deviation from logarithmic to linear scale is invoked with I′_{σ} as input and σ′ as output.

The RVS Mask in FIG. 11 is described as follows:

Residual and Variance Scale (RVS) scales both the residual and the standard deviation parameter used to create the entropy coding model. The position of residual scaling is after Gain Unit on encoder side. The position of inverse residual scaling is right after inverse Gain Unit as shown in FIG. 11. The process of RVS achieves adaptive quantization of residual samples based on their corresponding standard deviation value.

The input for RVS Mask generation process includes standard deviation tensor σ′ which is the output of the Sigma Scale module, and the output for the RVS Mask generation process is a mask_rvs. The output for the RVS Mask generation process is used as an input of the Inv RVS process, and then the Inv RVS process outputs a scaled residual tensor \hat{r}″.

The LSBS and LSBS Mask in FIG. 11 are described as follows:
Latent Scale Before Synthesis (LSBS) is applied at decoder side, it modifies reconstructed latent tensor ŷ based on signalled scaing factors. The input of the LSBS Mask generation process includes the standard deviation tensor σ″[C, h₄, w₄] which is the output of the Adaptive Sigma Scale process, the output of the LSBS Mask generation process is mask_Isbs, the mask_Isbs is used as an input of the LSBS process, then the LSBS process outputs the modified latent tensor ŷ[C, h₄, w₄].
In one embodiment, at the decoder, the input of the LSBS process are the residual tensor \hat{r}[C, h₄, w₄] after entropy decoding (and Skip Mode if applicable), the prediction tensor μ[C, h₄, w₄] after the prediction fusion process, latent tensor ŷ[C, h₄, w₄], and binary mask generated using standard deviation σ.

The Skip Mask and Decoder Skip in FIG. 11 are described as follows:

Skip Mode allows skip writing to/parsing from the bit-stream residual tensor elements which can be identified by encoder and decoder to be zeros. The input of the Skip Mask generation process includes the standard deviation tensor σ″[C, h₄, w₄] which is the output of the Adaptive Sigma Scale process, a compIdx: 0—primary (y) or 1—secondary (uv), and cube_luma_flag if (compIdx==0) or cube_chroma_flag[C, h_4, w_4] if (compIdx==1); the output of Skip Mask generation process is mask_skip, the mask_skip is used as an input of the Decoder Skip process, then the Decoder Skip process outputs the residual tensor \hat{r}[C, h₄, w₄]. Furthermore, an 1D array s[num_res_elements] after decoding by the me-tANS from the “stream−y” is also an input of the Decoder Skip process.

In one embodiment, the Skip mode process is described as follows:

The Skip mode process is also named as SKIP mode decoder process, or SKIP process, or Decoder side SKIP operation/process. At the decoder, the inputs of skip mode process include:
1D array s[num_res_elements] after decoding by me-tANS to from the “stream−y”
mask_skip[num_skip_params, C, h₄, w₄].

The output of this process is
the residual tensor \hat{r}[C, h₄, w₄].

The output of the lossless decoding process is a 1D array {sₖ}, whose size is equal to the total number of “1”s in the maskAggregate [C, h₄, w₄] tensor.

In other words, the maskAggregate [C, h₄, w₄] tensor determines which samples of the residual tensor \hat{r} are included in the bitstream. All of the other samples of the quantized residual tensor are inferred to be equal to zero.

The process of residual skip mode at the decoder is as follows:
Dimensions [C, h₄, w₄] are set equal to number of channels, height and width of the sigma tensor σ (Table 2).
Tensors \hat{r}[C, h₄, w₄] and maskAggregate [C, h₄, w₄] are initialized to be equal to all zeros and all ones respectively.
The counter k=0.
The following ordered operations are applied:
For c=0 . . . . C−1, i=0 . . . h₄−1, j=0 . . . w₄−1

$$\hat{r} [ c , i , j ] = mask\_skip [ c , i , j ] \cdot ( s [ k ] - {2}^{16 - 1} + 1 ) , k = k + 1.$$

The Synthesis Transform in FIG. 11 is described as follows:

An example of synthesis transform net is shown in FIG. 13.

The learning-based reconstruction (called synthesis transform) consists of two pipe-lines with identical neural network architecture, except input size and number of channels.

The input of analysis transform is
reconstructed latent space tensor ŷ of shape [C, h₄, w₄] concatenated with auxiliary information tensor \tilde{y}[C_{d}, h₄, w₄]
operation point indicator opIdx,
sizes of input/output tensor Hᵢₙ, Wᵢₙ,
model parameters for Synthesis transform Net defined by pair (modelIdx, opIdx)

The output of analysis transform is reconstructed colour component \hat{x} a tensor of size [Cᵢₙ, Hᵢₙ, Wᵢₙ].

Synthesis transform starts from concatenation of main latent tensor (ŷ[C, h₄, w₄]) and auxiliary (\tilde{y}[C_{d}, h₄, w₄]) input. The depending on operation point indicator (opIdx) decoder performs following sequence of operations.

For base operating point (opIdx=0) and primary component (compIdx=0) first step of synthesis transform (depth=4 of deep neural-network process) consists of one light weight residual block with number of channels C+C_{d} is followed by a transposed convolution with kernel size 4×4, which reduces the number of channels to C₃. This transposed convolution is proceeded by cropping layer (stride 2, depth 4) and residual activation unit. For the secondary component (compIdx=1) first step (depth=4) of synthesis transform is just latent combine block (LCB) which changes number of channels from C+C_{d} to C₃=2C. The next step (depth=3) for both components is a transposed convolution with kernel size 4×4, which changes the number of channels to C₂. This transposed convolution is proceeded by cropping layer (stride 2, depth 3) and residual activation unit. The next step (depth=2 and 1) of the process is regular convolution with kernel size 3×3, stride 1 and un-changed number of channels C₂ combined with residual activation unit. Then there is a stride 1 convolution 3×3 which increases the number of channels from C₂ to 16Cᵢₙ. This done in order to ensure that the output of the next layer (which is pixel shuffle with stride 4) has the number of channels Cᵢₙ. The process is concluded with cropping layer (stride 4, depth 1).

For high operating point (opIdx=1) and primary component (compIdx=0) first step of synthesis transform (depth=4 of deep neural-network process) consists of residual block with number of channels C+C_{d}, which is followed by a transposed convolutions with kernel size 4×4, which reduces the number of channels to C₃. This transposed convolution is combined with cropping layer (stride 2, depth 4) and residual activation unit. For the secondary component (compIdx=1) first step of synthesis stransform is just latent combine block (LCB) which changes number of channels from C+C_{d} to C₃. The next step (depth=3) for both components is a transposed convolutions with kernel size 4×4, which changes the number of channels to C₂. Convolution-based attention block is placed the next (it is denoted as CAB). It is followed by cropping layer (stride 2, depth 3) and residual activation unit.

The next step (depth=2) of the process is regular convolution with kernel size 1×1, stride 1 and number of output channels is 4C₁. This done in order to ensure that the output of the next layer (which is pixel shuffle with stride 2) has the number of channels C₁. The last step (depth=1) starts with transformer-based attention module (denoted as TAM (compIdx)), followed by with cropping layer (stride 2, depth 2) and residual activation unit with kernel size 3×3 are performed. The process is concluded by transposed convolutions with kernel size 3×3, stride 2, the number of output channels Cᵢₙ, followed by cropping layer (stride 2, depth 1).

The Multistage Context Modelling (MCM) is described as follows:

| | |
|---|---|
| | The input of this MCM process is |
| - | operation point indicator opIdx, |
| - | \hat{r} [C, h₄, w₄] reconstructed residual tensor, which is an out out of SKIP Model |
| | process, |
| - | p [2C, h₄, w₄] explicit prediction, which is an output of Hyper Decoder, |
| - | Eight MCMₖ , k=0,...7 models with parameters defined by (modelIdx, k) |
| | The output of this MCM process is |
| - | ŷ′ [C, h₄, w₄] reconstructed latent tensor. |
| | The MCM process consists of following operations: |
| - | padding layer (depth =5, stride =2) followed by down-shuffle M=2 of explicit |
| | prediction tensor p[2C, h₄, w₄] to \ddot{p}[8C, h₅, w₅] re-shaped prediction tensor, |
| - | padding layer (depth =5, stride =2) followed by down-shuffle M=1 of |
| | reconstructed resdiaul \hat{r}[C, h₄, w₄] to \ddot{r}[4C, h₅, w₅] re-shaped residual tensor, |
| - | split \ddot{p}[8C, h₄, w₄] into four parts \ddot{p}ₗ = \ddot{p}[2lC: 2(l + 1)C − 1, h₅, w₅], l = 0, ...,3 (each |
| | parts consists of 2C out of 8C channels) |
| - | split \ddot{r}[4C, h₄, w₄] into eight parts \ddot{r}ₖ = \ddot{r}[kC /2: (k + 1)C /2 − 1, h₅, w₅], k = 0, ...,7 |
| | (each parts consists of C/2 out of 4C channels) |
| - | For k=0, ... , 3 |

| | |
|---|---|
| ∘ | MCM(k) process which |

| | |
|---|---|
| ▪ | takes as an input |

| | |
|---|---|
| • | {ÿₘ}, m = 0, ... , k − 1 previously reconstructed parts of re- |
| | shaped latent space tensor |
| • | \ddot{r}ₖ - collocated part of reconstructed residual tensor |
| • | \ddot{p}_{k%4}- part of re-shaped explicit prediction tensor |

| | |
|---|---|
| ▪ | outputs |

| | |
|---|---|
| • | produces ÿₖ = ÿ[kC /2: (k + 1)C /2 − 1, h₄/2, w₄/2] |

| | |
|---|---|
| - | Channel net process over ÿ[0: (2C − 1, h₅, w₅] tensor |
| - | For k=3,...,7 |

| | |
|---|---|
| ∘ | MCM(k) process which |

| | |
|---|---|
| ▪ | takes as an input |

| | |
|---|---|
| • | {ÿₘ}, m = 0, ... , k − 1 previously reconstructed parts of re- |
| | shaped latent space tensor |
| • | \ddot{r}ₖ - collocated part of reconstructed residual tensor |
| • | \ddot{p}_{k%4}- part of re-shaped explicit prediction tensor |

| | |
|---|---|
| ▪ | outputs |

| | |
|---|---|
| • | produces ÿₖ = ÿ[kC /2: (k + 1)C /2 − 1, h₅, w₅] |

| | |
|---|---|
| - | up-shuffle M=2 followed by cropping layer (depth =5, stride =2) ÿ[4C, h₅, w₅] to |
| | ŷ′[C, h₄, w₄]. |
| - | up-shuffle M=2 \ddot{μ}[4C, h₅, w₅] to μ[C, h₄, w₄] (to be further used in LSBS process. |

An example of Multi-stage context modelling process is described. The MCM process is a recurrent process: later stages uses previously obtained elements of output tensor as an input.

### Down-Shuffle Operation

| | |
|---|---|
| | The input of this process is |
| - | M - number of tensor slices |
| - | a[MC, h₄, w₄] - 3D tensor. |
| | The output of this process is |
| - | ä[4MC, h₅, w₅] re-shuffled 3D tensor with same elements |

In the down-shuffle operation, input slice first split into M in channel dimension, then for each slice elements of tensor are grouped into four groups: 0, 1, 2 and 3 (please note, groups number is not raster order, but zig-zag order), and those groups are re-shuffled in channel dimension.

Since down-shuffle operation changes spatial size of tensor similar way as down-sampling convolution with stride 2, this down-shuffle process is preceded by padding layer (h₄, w₄, 1, 2). Zero-padding is performed. In other words, down-shuffling is used to change tensor size or shape.

### Up-Shuffle Operation

This process is inverse to down-shuffle operation.

| | |
|---|---|
| | The input of this process is |
| - | M - number of tensor slices |
| - | ä[4MC, h₅, w₅] 3D tensor. |
| | The output of this process is |
| - | re-shuffled 3D tensor a[MC, h₄, w₄] with same elements |

In the up-shuffle operation, input slice first split into M in channel dimension, then for each slice elements of tensor are re-shuffled in zig-zag order, then number of channels is reduced four times, spatial dimension is increased twice.

Since up-shuffle operation changes spatial size of tensor similar way as inverse convolution with stride 2, this up-shuffle operation process is followed by cropping layer (h₄, w₄, 1, 2). In other words, up-shuffling is used to change tensor size or shape.

### Stage 0 of Multistage Context Modelling

| | |
|---|---|
| | The input of this process is |
| - | \ddot{p}₀ = \ddot{p}[0: 2C − 1, h₅, w₅] - part k=0 of re-shuffled explicit prediction tensor, |
| - | \ddot{r}₀ = \ddot{r}[0: C /2 − 1, h₅, w₅]- part k=0 of re-shuffled residual tensor, |
| - | Prediction Fusion Net parameters for k = 0. |
| | The output of this process is |
| - | ÿₖ = ÿ[0: C /2 − 1, h₅, w₅] - part k = 0 of re-shaped latent space tensor. |
| | The process is as follows: |
| - | \ddot{p}₀ goes though channel padding 2C → 3C producing a₀[3C, h₅, w₅], |
| - | a₀[3C, h₄/2, w₄/2] goes to prediction fusion net k = 0 , which produces \ddot{μ}₀ = |
| | \ddot{μ}[0: C /2 − 1, h₅, w₅] |
| - | ÿ₀ = \ddot{μ}₀ + \ddot{r}₀. |

### Stage 1 of Multistage Context Modelling

| | |
|---|---|
| | The input of this process is |
| - | \ddot{p}₁ = \ddot{p}[2C: 4C − 1, h₅, w₅] - part k=1 of re-shuffled explicit prediction tensor, |
| - | \ddot{r}₁ = \ddot{r}[C /2: C − 1, h₅, w₅]- part k=1 of re-shuffled residual tensor, |
| - | ÿ₀ = ÿ[0: C /2 − 1, h₅, w₅]- part k=0 of re-shuffled reconstructed latent tensor, |
| - | trained parameters of CONVₖ₌₁(3 × 3, C /2, C /2), |
| | Prediction Fusion Net parameters for k = 1. |
| | The output of this process is |
| - | ÿₖ = ÿ[C /2: C − 1, h₅, w₅] - part k = 1 of re-shaped latent space tensor. |
| | The process is as follows: |
| - | ÿ₀ goes though convolution layer CONV(3 × 3, C /2, C /2) which produces \tilde{ÿ}₀ of |
| | size [C /2, h₅, w₅], |
| - | \ddot{p}₀ goes though channel padding 2C → 5C /2 producing P[5C /2, h₅, w₅], |
| - | \tilde{ÿ}₀ and P₁ concatenated to form a₁ and go to prediction fusion net k = 1, which |
| | produces \ddot{μ}₁ = \ddot{μ}[C /2: C − 1, h₅, w₅] |
| - | ÿ₁ = \ddot{μ}₁ + \ddot{r}₁. |

### Stage 2 of Multistage Context Modelling

| | |
|---|---|
| | The input of this process is |
| - | \ddot{p}₂ = \ddot{p}[4C: 6C − 1, h₅, w₅] - part k=2 of re-shuffled explicit prediction tensor, |
| - | \ddot{r}₂ = \ddot{r}[C: 3C /2 − 1, h₅, w₅]- part k=2 of re-shuffled residual tensor, |
| - | ÿ_{0...1}[0: C − 1, h₅, w₅]- parts k=0 and k=1 of re-shuffled reconstructed latent |
| | tensor, |
| - | trained parameters of CONVₖ₌₂(3 × 3, C, C /2), |
| - | Prediction Fusion Net parameters for k = 2. |
| | The output of this process is |
| - | ÿₖ = ÿ[C: 3C /2 − 1, h₅, w₅] - part k = 2 of re-shaped latent space tensor. |
| | The process is as follows: |
| - | ÿ₀ and ÿ₁ concatenated and go through convolution layer CONV(3 × 3, C, C /2) |
| | which produces \tilde{ÿ}₁ of size [C /2, h₅, w₅], |
| - | \ddot{p}₂ goes though channel padding 2C → 5C /2 producing P[5C /2, h₅, w₅], |
| - | \tilde{ÿ}₁ and P₂ concatenated to form a₂ and go to prediction fusion net k = 2 , which |
| | produces \ddot{μ}₂ = \ddot{μ}[C: 3C /2 − 1, h₅, w₅] |
| - | ÿ₂ = \ddot{μ}₂ + \ddot{r}₂. |

### Stage 3 of Multistage Context Modelling

| | |
|---|---|
| | The input of this process is |
| - | \ddot{p}₃ = \ddot{p}[6C: 8C − 1, h₅, w₅] - part k=3 of re-shuffled explicit prediction tensor, |
| - | \ddot{r}₃ = \ddot{r}[3C /2: 2C − 1, h₅, w₅]- part k=3 of re-shuffled residual tensor, |
| - | ÿ_{0...2}[0: 3C /2 − 1, h₅, w₅]- parts k=0 , k=1 and k=2 of re-shuffled reconstructed |
| | latent tensor, |
| - | trained parameters of CONVₖ₌₃(3 × 3, 3C /2, C /2), |
| - | Prediction Fusion Net parameters for k = 3. |
| | The output of this process is |
| - | ÿₖ = ÿ[3C /2: 2C − 1, h₅, w₅] - part k = 3 of re-shaped latent space tensor. |
| | The process is as follows: |
| - | ÿ₀ , ÿ₁ and ÿ₂ concatenated and go though convolution layer CONV(3 × |
| | 3, 3C /2, C /2) which produces \tilde{ÿ}₂ of size [C /2, h₅, w₅], |
| - | \ddot{p}₃ goes though channel padding 2C → 5C /2 producing P[5C /2, h₅, w₅], |
| - | \tilde{ÿ}₂ and P₃ concatenated to form a₃ and go to prediction fusion net k = 3 , which |
| | produces \ddot{μ}₃ = \ddot{μ}[3C /2: 2C − 1, h₅, w₅] |
| - | ÿ₃ = \ddot{μ}₃ + \ddot{r}₃. |

### Stage 4 of Multistage Context Modelling

| | |
|---|---|
| | The input of this process is |
| - | \ddot{p}₀ = \ddot{p}[0: 2C − 1, h₅, w₅] - part k=0 of re-shuffled explicit prediction tensor, |
| - | \ddot{r}₄ = \ddot{r}[2C: 5C /2 − 1, h₅, w₅]- part k=4 of re-shuffled residual tensor, |
| - | \tilde{y}₀ = \tilde{y}[0: C /2 − 1, h₅, w₅] - the part k=0 of the output from Channel Net( E.5.4 ), |
| - | Prediction Fusion Net parameters for k = 4. |
| | The output of this process is |
| - | ÿₖ = ÿ[2C: 3C /2 − 1, h₅, w₅] - part k = 4 of re-shaped latent space tensor. |
| | The process is as follows: |
| - | \ddot{p}₀ goes though channel padding 2C → 5C /2 producing P₄[5C /2, h₅, w₅]_{,} |
| - | \tilde{y}₀ and P₄ concatenated to form a₄ and go to prediction fusion net k = 4 , which |
| | produces \ddot{μ}₄ = \ddot{μ}[2C: 5C /2 − 1, h₅, w₅] |
| - | ÿ₄ = \ddot{μ}₄ + \ddot{r}₄. |

### Stage 5 of Multistage Context Modelling

| | |
|---|---|
| | The input of this process is |
| - | \ddot{p}₁ = \ddot{p}[2C: 4C − 1, h₅, w₅] - part k=1 of re-shuffled explicit prediction tensor, |
| - | \ddot{r}₅ = \ddot{r}[5C /2: 3C − 1, h₅, w₅]- part k=5 of re-shuffled residual tensor, |
| - | \tilde{y}₁ = \tilde{y}[C /2: C − 1, h₅, w₅] - the part k=1 of the output from Channel Net( E.5.4 ), |
| - | ÿ₄ = ÿ[2C: 3C /2 − 1, h₅, w₅] - part k = 4 of re-shaped latent space tensor, |
| - | trained parameters of CONVₖ₌₅(3 × 3, C /2, C /2) |
| - | Prediction Fusion Net parameters for k = 5. |
| | The output of this process is |
| - | ÿₖ = ÿ[5C /2: 3C − 1, h₅, w₅] - part k = 5 of re-shaped latent space tensor. |
| | The process is as follows: |
| - | ÿ₄ = ÿ[2C: 3C /2 − 1, h₅, w₅] goes though convolution layer CONV(3 × |
| | 3, C /2, C /2) which produces \tilde{ÿ}₄ of size [C /2, h₅, w₅]_{,} |
| - | \tilde{y}₁ , \tilde{ÿ}₄ and \ddot{p}₁ concatenated to form a₅ and go to prediction fusion net k = 5 , |
| | which produces \ddot{μ}₅ = \ddot{μ}[5C /2: 3C − 1, h₄/2, w₄h₅, w₅/2] |
| | ÿ₅ = \ddot{μ}₅ + \ddot{r}₅ |

### Stage 6 of Multistage Context Modelling

| | |
|---|---|
| | The input of this process is |
| - | \ddot{p}₂ = \ddot{p}[4C: 6C − 1, h₅, w₅] - part k=2 of re-shuffled explicit prediction tensor, |
| - | \ddot{r}₆ = \ddot{r}[3C: 5C /2 − 1, h₅, w₅]- part k=6 of re-shuffled residual tensor, |
| - | \tilde{y}₂ = \tilde{y}[C: 3C /2 − 1, h₅, w₅] - the part k=2 of the output from Channel Net( E.5.4 |
| | ), |
| - | ÿ₄,\ddot{ }ÿ₅ - parts k = 4, 5 of re-shaped latent space tensor, |
| - | trained parameters of CONVₖ₌₆(3 × 3, C, C /2) |
| - | Prediction Fusion Net parameters for k = 6. |
| | The output of this process is |
| - | ÿₖ = ÿ[3C: 5C /2 − 1, h₅, w₅] - part k = 6 of re-shaped latent space tensor. |
| | The process is as follows: |
| - | ÿ₄ and ÿ₅ concatenated and go though convolution layer CONV(3 × 3, C, C /2) |
| | which produces \tilde{ÿ}₅ of size [C /2, h₅, w₅], |
| - | \tilde{y}₂ , \tilde{ÿ}₅ and \ddot{p}₂ concatenated to form a₆ and go to prediction fusion net k = 6 , |
| | which produces \ddot{μ}₆ = \ddot{μ}[3C: 5C /2 − 1, h₅, w₅] |
| - | ÿ₆ = \ddot{μ}₆ + \ddot{r}₆. |

### Stage 7 of Multistage Context Modelling

| | |
|---|---|
| | The input of this process is |
| - | \ddot{p}₃ = \ddot{p}[6C: 8C − 1, h₅, w₅] - part k=3 of re-shuffled explicit prediction tensor, |
| - | \ddot{r}₇ = \ddot{r}[5C /2: 4C − 1, h₅, w₅]- part k=7 of re-shuffled residual tensor, |
| - | \tilde{y}₃ = \tilde{y}[3C /2: 2C − 1, h₅, w₅] - the part k=3 of the output from Channel Net( |
| | E.5.4 ), |
| - | ÿ₄, ÿ₅, ÿ₆ - parts k = 4, 5,6 of re-shaped latent space tensor, |
| - | trained parameters of CONVₖ₌₇(3 7× 3, 3C /2, C /2) |
| - | Prediction Fusion Net parameters for k = 7. |
| | The output of this process is |
| - | ÿₖ = ÿ[5C /2: 4C − 1, h₅, w₅] - part k = 7 of re-shaped latent space tensor. |
| | The process is as follows: |
| - | ÿ₄, ÿ₅ and ÿ₆ concatenated and go though convolution layer CONV(3 × |
| | 3, 3C /2, C /2) which produces \tilde{ÿ}₆ of size [C /2, h₅, w₅], |
| - | \tilde{y}₃ , \tilde{ÿ}₆ and \ddot{p}₃ concatenated to form a₇ and go to prediction fusion net k = 7 , |
| | which produces \ddot{μ}₇ = \ddot{μ}[5C /2: 4C − 1, h₅, w₅] |

ÿ₇ = \ddot{μ}₇ + \ddot{r}₇.

### MCM Design Elements

Three types of operations which change tensor size or shape: 1) down-shuffle, 2) upshuffle, 3) channel-wise padding. And two sub-networks Channel Net and Prediction Fusion Net.

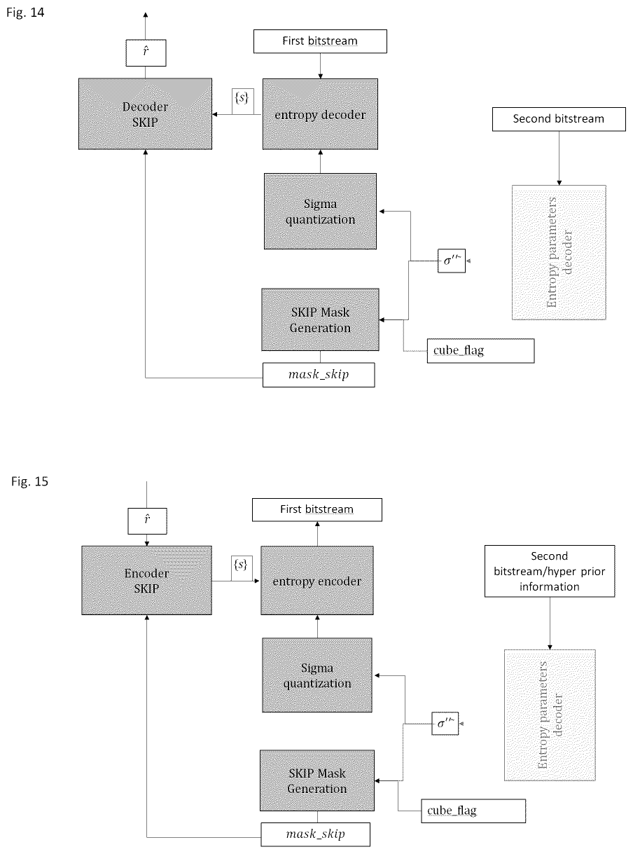

FIG. 14 shows an example of a decoder structure, where the decoder structure includes an entropy parameters decoder, a Skip mask generation process, a sigma quantization process, an entropy decoder and a decoder skip process.

The inputs of the entropy decoder include: a first bitstream and a sigma index, where the sigma index is used to indicate an index of probability distribution table and is needed for parsing symbols interpretation. The output of the entropy decoder includes a sequence of decoded symbols {s}, the decoded symbols {s} cannot be equalled as residual, because not all residual elements are coded.

The inputs of the Decoder skip process include: the sequence of decoded symbols {s} outputed from the entropy decoder and a sigma mask (or skip mask), where the sigma mask is used to know which residual symbols were coded, and which were not and must be set to 0. The output of the Decoder Skip includes a sequence of decoded symbols residual. At decoder side the decoded symbols residual \hat{r} is scaled by Inverse Gain Unit according to the parameter β, to produce \hat{r}′. Then resildual tensor is scaled in inv RVS (Inverse Residual and Variance Scale) module forming residual tensor \hat{r}″. And the residual tensor \hat{r}″ is used for reconstructed latent tensor ŷ. And the reconstructed latent tensor ŷ is used to obtain reconstructed colour component \hat{x}, the \hat{x} is a tensor of size [Cᵢₙ, Hᵢₙ, Wᵢₙ]. Furthermore, the reconstructed colour components might be re-sampled to original picture size and combined to obtain the enhanced YUV signal, the the enhanced YUV signal is processed by inverse colour transform process to obtain RGB signal of the reconstructed image.

The inputs of the sigma quantization process includes a sigma (variance value) from the entropy parameters decoder, and the output of the sigma quantization process includes the sigma index which is used as an input of the entropy decoder. In other words, the sigma (variance value) from the entropy parameters decoder (tensor σ″ values) are quantized inside the Sigma quantization process, in this Sigma quantization process, the tensor σ″ values are converted to the sigma index of the probability distribution table. The entropy decoder decodes the input first bitstream based on the sigma index and the stored probability distribution table to obtain the sequence of decoded symbols. In an embodiment, the inputs of the sigma quantization process includes the sigma value in the logarithmic space, the sigma index is obtained based on the logarithmic value of the sigma value, in this embodiment, the output of the entropy parameters decoder is the logarithmic value of the sigma value.

In one embodiment, the table for conversion of standard deviation from logarithmic scale to linear scale is described as follows:

Table LogToLinear is used to convert standard deviation from logarithmic scale to linear and back. The values are stored in sigmaPrecision precision. Size of the table is equal to (N_{σ}−1)<<sigmaPrecision.

NOTE—Table LogToLinear is obtained using equation

$$σ ( idx ) = [ {2}^{17} \cdot exp ( \frac{idx \cdot ( ln ( {σ}_{max} ) - ln ( {σ}_{min} ) )}{34 \cdot {2}^{7}} + ln ( {σ}_{min} ) ) ]$$

$$for idx = 0 … ( ( {N}_{σ} - 1 ≪ sigmaPrecision ) - 1 , {N}_{σ} = 32 , {σ}_{min} = 0.2 ,$$

$${σ}_{max} = 30 ,$$

The inputs of the Skip mask generation process include the sigma (variance value) from the entropy parameters decoder (tensor σ″ values or logarithmic values of σ″ values) and a cube_flag, where the cube_flag is selected by the encoder and are transmitted to the decoder. The output of the Skip mask generation process includes a sigma mask, where the sigma mask is used as one input of the Decoder skip process to know which residual symbols were coded, and which were not and must be set to 0.

The input of the entropy parameters decoder includes a second bitstream, and the output of the entropy parameters decoder includes the sigma (variance value, denoted as σ″) or the log value of the sigma (denoted as log σ″), the sigma is a variance value related with the probability distribution information of the first bitstream.

The entropy parameters decoder can be implemented by a neural network, the neural network might includes an entropy decoder, an hyper scale decoder, a sigma scale process, and an adaptive sigma scale process, where the entropy decoder is used to parse the second bitstream to obtain decoded hyper-prior tensors \hat{z}, in one example, the probability distribution for loss-less coding of \hat{z} is assumed to be Gaussian with pre-trained parameters. Then, the decoded hyper-prior tensors \hat{z} is processed by the hyper scale decoder to obatin first sigma tensors σ, and then the first sigma tensors are processed by the sigma scale process to obtain second sigma tensors σ′, further then, the second sigma tensors are procesed by the adaptive sigma scale process to obtain third sigma tensors σ″. The third sigma tensors σ″ are the above sigma (variance values) which are the output of the entropy parameters decoder and are the input of the sigma quantization process and the input of the skip mask generation process. In one example, the sigma scale process includes scalling process according to the rate control parameter β, and the Adaptive Sigma Scale process includes masking and scalling process according to RVS parameters.

FIG. 15 shows an example of a encoder structure, where the encoder structure includes an entropy parameters decoder, a Skip mask generation process, a sigma quantization process, an entropy encoder and an encoder skip process.

The input of the entropy parameters decoder includes a second bitstream, the second bitstream includes hyper prior information of an image that is encoded in the first bitstream, the second bitstream is obtained by a hyper encoder processing the image data, and the output of the entropy parameters decoder includes the sigma (variance value, in linear domain, denoted as σ″) or the log value of the sigma (denoted as log σ″), the sigma is a variance value related with the probability distribution information of the first bitstream. In one embodiment, the input of the entropy parameters decoder is hyper prior information instead of the second bitstream, that is the encoder structure doesn't need to parse the hyper prior information from the second bitstream.

The entropy parameters decoder might includes an entropy decoder, an hyper scale decoder, a sigma scale process, and an adaptive sigma scale process, where the entropy decoder is used to parse the second bitstream to obtain decoded hyper-prior tensors \hat{z}, in one example, the probability distribution for loss-less coding of \hat{z} is assumed to be Gaussian with pre-trained parameters. Then, the decoded hyper-prior tensors \hat{z} is processed by the hyper scale decoder to obatin first sigma tensors σ, and then the first sigma tensors are processed by the sigma scale process to obtain second sigma tensors σ′, further then, the second sigma tensors are procesed by the adaptive sigma scale process to obtain third sigma tensors σ″. The third sigma tensors σ″ are the sigma (variance values) which are the output of the entropy parameters decoder and are the input of the sigma quantization process and the input of the skip mask generation process. In one example, the sigma scale process includes scalling process according to the rate control parameter β, and the Adaptive Sigma Scale process includes masking and scalling process according to RVS parameters.

The sigma quantization process and the skip mask generation process in FIG. 15 are the same as the sigma quantization process and the skip mask generation process in FIG. 14.

The inputs of the encoder skip process includes a sigma mask (or a skip mask) from the skip mask generation process and a sequence of symbols residual, the output of the encoder skip process includes a sequence of encoded symbols {s}.

The inputs of the entropy encoder include: the sigma index from the sigma quantization process and the sequence of encoded symbols {s} from the encoder skip process, where the sigma index is used to indicate an index of probability distribution table and is needed for encoding the symbols {s}. The output of the entropy decoder is a bitstream that includes encoded data of an input image.

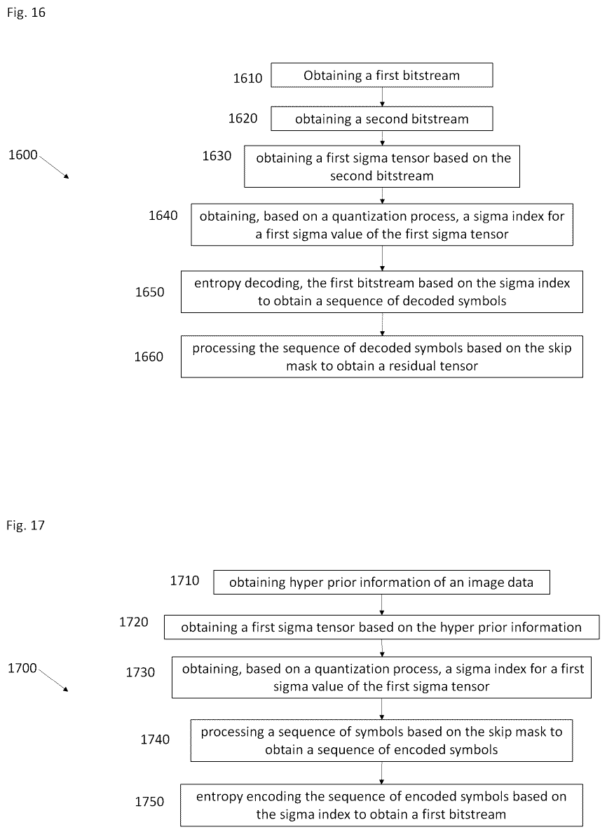

One embodiment of the present application discloses a method for decoding a bitstream as shown in FIG. 16, where the method 1600 includes:
1610. obtaining a first bitstream;

One can understand that the first bitstream includes encoded image data or video data.
1620. obtaining a second bitstream;

Where the second bitstream comprises hyper prior information of the first bitstream, in other words, the second bitstream comprises hyper prior information of the encoded image data or video data in the first bitstream. The hyper prior information can also be called as hyper-parameters tensor or hyper-parameters.
1630. obtaining a first sigma tensor based on the second bitstream;

Where the first sigma tensor comprises several sigma values or standard deviation values, wherein the sigma values are variance values related with probability distribution information of the first bitstream; the standard deviation values are related with probability distribution information of first bitstream. In other words, the first sigma tensor includes variance values and the standard deviation values of samples of the first bitstream.
1640. obtaining, based on a quantization process, a sigma index for a first sigma value of the first sigma tensor;

Where the sigma index indicates one of probability distributions in a probability distribution table, wherein a minimum sigma value of the quantization process is set equal to a skip threshold, wherein the skip threshold is used in a skip process to obtain a skip mask;

The skip mask can also be called as a sigma mask. Skip is widely used for improving throughput of arithmetic coder. Skip logic results in not encoding some elements with variance/standard deviation lower than skip threshold. One can understand that if the sigma value is wrong (such as too small), the skip process will be disabled based on a cube_flag. If the skip process is enabled, due to Skip process, all residual elements with σ″<(threshold_skip) will not be coded and will be set to 0, which means Sigma_Idx for σ″<(threshold_skip) is never used. Thus, if the σₘᵢₙ is set to be less than (threshold_skip), sigma_index for σ″ between the σₘᵢₙ and the (threshold_skip) will never be used, which causes codec resources wasting and coding efficiency reducing, and especially leads to improperly occupy of the memory resources. Thus, the present application proposes that the σₘᵢₙ is modified to be equal to the threshold_skip in the Skip logic (such as the threshold used in the Skip Mask process). In one specific embodiment, σₘᵢₙ=(threshold_skip). In one specific embodiment, the threshold_skip is set as a default value 0.2, as a result, the σₘᵢₙ can be modified as 0.2. If the threshold_skip is set as other default value, the σₘᵢₙ should be modified to be equal to the default value of the threshold_skip.
1650. entropy decoding, the first bitstream based on the sigma index to obtain a sequence of decoded symbols;
1660. processing the sequence of decoded symbols based on the skip mask to obtain a residual tensor, wherein the residual tensor is used to obtain a reconstructed image.

Based on the skip mask, the decoder can know which symbols were codede and which were not and have been set to 0. Thus the decoder can resconstruct the residual tensor.

In one embodiment, the skip mask is used to indicate which elements of a second tensor are present in the second bitstream, where the second tensor is based on the value of sigma derived from the first sigma tensor.

In one embodiment, the minimum sigma value of the quantization process is set equal to 0.2.

In one embodiment, the minimum sigma value of the quantization process is set equal to threshold_skip<<shift, wherein the threshold_skip indicates the skip threshold, wherein the shift indicates.

In one embodiment, a maximum sigma value of the quantization process is set equal to 30.

In one embodiment, a maximum sigma value of the quantization process is set equal to a value in a range of 30 to 64.

In one embodiment, the quantization process quantizes a sigma value in the first sigma tensor into a sigma value among several discrete values in a range from the minimum sigma value to the maximum sigma value.

In one embodiment, a sigma number of the quantization process is set as a power of 2, wherein the sigma number indicates the number of the probability distributions in the probability distribution table.

In one embodiment, a sigma number of the quantization process is set as a power of 2, the sigma number indicates the number of the discrete values in the range.

In one embodiment, the sigma number of the quantization process is set equal to 32.

In one embodiment, the obtaining the first sigma tensor based on the second bitstream comprises: entropy decoding the second bitstream to obtain a decoded hyper-prior tensor; processing, based on a hyper scale decoder, the decoded hyper-prior tensor to obtain a second sigma tensor; scaling the second sigma tensor to obtain the first sigma tensor.

In one embodiment, the first sigma tensor comprises the sigma values or the standard deviation values in logarithmic domain.

In one embodiment, the output of the hyper scale decoder is a log domain sigma tensor, the first sigma tensor is a scaled log domain sigma tensor.

In one embodiment, wherein the first sigma value is a linear domain standard deviation value or a linear domain variance value.

In one embodiment, the obtaining, based on the quantization process, the sigma index for the first sigma value comprises:
obtaining the sigma index based on the following equation:

$$sigma\_Idx = clip ( ( {I}_{σ}^{″} + {2}^{sigmaPrecision - 1} ) ≫ sigmaPrecision , 0 , {N}_{σ} - 1 ) .$$

wherein the sigma_idx represents the sigma index, the I_{σ}″ represents the first sigma value in the logarithmic domain, or the I_{σ}″ represents the standard deviation value in the logarithmic domain, the sigmaPrecision is equal to 7, the N_{σ} is equal to 32.

In one embodiment, where the obtaining, based on the quantization process, the sigma index for the first sigma value comprises:
obtaining the sigma index based on the following equation:

$$sigma\_Idx = i , {b}_{i} \leq {σ}^{″} < {b}_{i + 1}$$

$${b}_{i} = exp ( ( ln ( {σ}_{max} ) - ln ( {σ}_{min} ) ) \cdot ( i + 0.5 ) / ( {N}_{σ} - 1 ) + ln ( {σ}_{min} ) )$$

$$i = 0 , … , {N}_{σ} - 1$$

wherein the sigma_idx represents the sigma index, the σ″ represents the first sigma value in a linear domain, the σₘᵢₙ is the minimum sigma value, the σₘₐₓ is the maximum sigma value, the N_{σ} is the sigma number.

In one embodiment, the N_{σ} is equal to 32.

In one embodiment, the σₘᵢₙ is equal to 0.2.

In one embodiment, σₘₐₓ is a value in a range of 30 to 64.

One embodiment of the present application discloses a method for encoding a bitstream as shown in FIG. 17, where the method 1700 includes:
1710. obtaining hyper prior information of an image data;

In the encoder side, the image data and the hyper prior information are encoded into two bitstreams.
1720. obtaining a first sigma tensor based on the hyper prior information;

Where the first sigma tensor comprises several sigma values or standard deviation values, wherein the sigma values are variance values related with probability distribution information of the image data; the standard deviation values are related with the probability distribution information of first bitstream. In other words, the first sigma tensor includes variance values and the standard deviation values of samples of the first bitstream.
1730. obtaining, based on a quantization process, a sigma index for a first sigma value of the first sigma tensor;

Wherein the sigma index indicates one of probability distributions in a probability distribution table, wherein a minimum sigma value of the quantization process is set equal to a skip threshold, wherein the skip threshold is used in a skip process to obtain a skip mask. Skip is widely used for improving throughput of an arithmetic coder. Skip logic results in not encoding some elements with variance/standard deviation lower than skip threshold. One can understand that if the sigma value is wrong (such as too small), the skip process will be disabled based on a cube_flag. If the skip process is enabled, due to Skip process, all residual elements with σ″<(threshold_skip<<shift) will not be coded and will be set to 0, which means Sigma_Idx for σ″<(threshold_skip<<shift) is never used. Thus, if the σₘᵢₙ is set to be less than (threshold_skip<<shift), sigma_index for σ″ between the σₘᵢₙ and the (threshold_skip<<shift) will never be used, which causes codec resources wasting and coding efficiency reducing, and especially leads to improperly occupy of the memory resources. Thus, the present application proposes that the σₘᵢₙ is modified to be equal to the threshold_skip in the Skip logic (such as the threshold used in the Skip Mask process). In one specific embodiment, min=(threshold_skip<<shift). In one specific embodiment, the threshold_skip is set as a default value 0.2, as a result, the σₘᵢₙ can be modified as 0.2. If the threshold_skip is set as other default value, the σₘᵢₙ should be modified to be equal to the default value of the threshold_skip.
1740. processing a sequence of symbols based on the skip mask to obtain a sequence of encoded symbols;
1750. entropy encoding the sequence of encoded symbols based on the sigma index to obtain a first bitstream.

In one embodiment, a maximum sigma value of the quantization process is set equal to a value in a range of 30 to 64.

In one embodiment, a maximum sigma value of the quantization process is set equal to 30.

In one embodiment, the quantization process quantizes a sigma value in the first sigma tensor into a sigma value among several discrete values in a sigma range from the minimum sigma value to the maximum sigma value.

In one embodiment, a sigma number of the quantization process is set as a power of 2, wherein the sigma number indicates the number of the probability distributions in the probability distribution table.

In one embodiment, a sigma number of the quantization process is set as a power of 2, the sigma number indicates the number of the discrete values in the range.

In one embodiment, the sigma number of the quantization process is set equal to 32.

In one embodiment, the first sigma tensor comprises the sigma values or the standard deviation values in logarithmic domain.

In one embodiment, the obtaining, based on the quantization process, the sigma index for the first sigma value comprises:
obtaining the sigma index based on the following equation:

$$sigma\_Idx = clip ( ( {I}_{σ}^{″} + {2}^{sigmaPrecision - 1} ) ≫ sigmaPrecision , 0 , {N}_{σ} - 1 ) .$$

wherein the sigma_idx represents the sigma index, the I_{σ}″ represents the first sigma value in the logarithmic domain, the sigmaPrecision is equal to 7, the N_{σ} is equal to 32.

In one embodiment, the input of the sigma quantization process is standard deviation values in linear of logarithmic domain, or in other words, the input of the sigma quantization process is log-domain standard deviation tensor I″_{σ}. And the sigma quantization process convert the log-domain standard deviation tensor to a sigma index.

In one embodiment, where the first sigma value is a logarithmic domain standard deviation value or a logarithmic domain variance value.

In one embodiment, where the first sigma value is a linear domain standard deviation value or a linear domain variance value.

In one embodiment, where the obtaining, based on the quantization process, the sigma index for the first sigma value comprises:
obtaining the sigma index based on the following equation:

$$sigma\_Idx = i , {b}_{i} \leq {σ}^{″} < {b}_{i + 1}$$

$${b}_{i} = exp ( ( ln ( {σ}_{max} ) - ln ( {σ}_{min} ) ) \cdot ( i + 0.5 ) / ( {N}_{σ} - 1 ) + ln ( {σ}_{min} ) )$$

$$i = 0 , … , {N}_{σ} - 1$$

wherein the sigma_idx represents the sigma index, the σ″ represents the first sigma value in a linear domain, the σₘᵢₙ is the minimum sigma value, the σₘₐₓ is the maximum sigma value, the N_{σ} is the sigma number.

In one embodiment, the N_{σ} is equal to 32.

In one embodiment, the σₘᵢₙ is equal to 0.2.

In one embodiment, σₘₐₓ is a value in a range of 30 to 64.

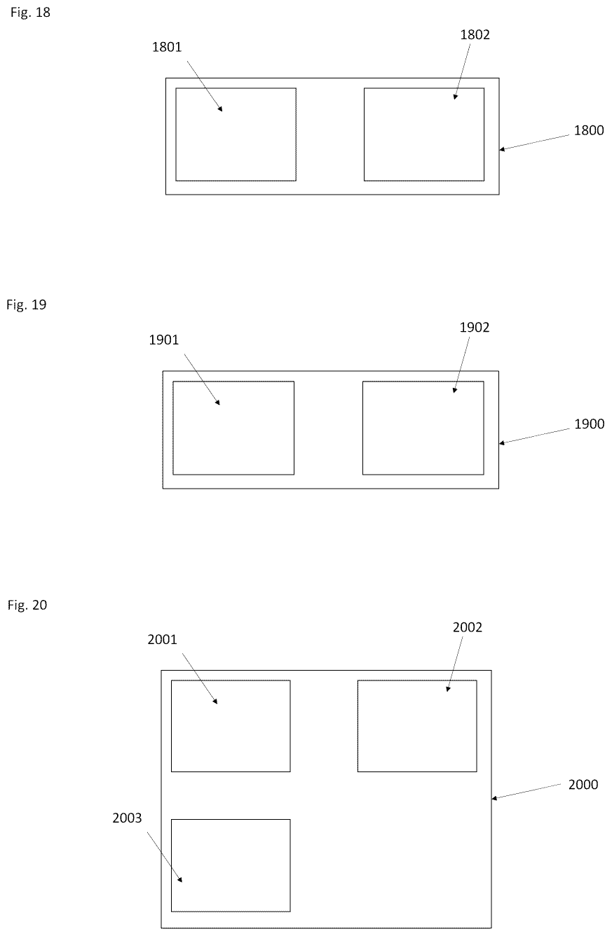

FIG. 18 shows an exemplary block diagram of a decoder structure, the decoder 1800 includes a storage medium 1801 and one or more processors 1802, the storage medium 1801 is configured to store computer executable instructions, the one or more processors 1802 are configured to perform the foregoing method 1600 and any one of the related embodiments.

FIG. 19 shows an exemplary block diagram of an encoder structure, the encoder 1900 includes a storage medium 1901 and one or more processors 1902, the storage medium 1901 is configured to store computer executable instructions, the one or more processors 1902 are configured to perform the foregoing method 1700 and any one of the related embodiments.

FIG. 20 shows an exemplary block diagram of a decoder structure, the decoder 2000 includes a receiver 2001, a transmitter 2002 and one or more processors 2003, the receiver 2001 is configured to receive a first bitstream and a second bitstream, the transmitter 2002 is configured for outputting a decoded picture, and the one or more processors 2003 are configured to perform the foregoing method 1600 and any one of the related embodiments.

FIG. 21 shows an exemplary block diagram of an encoder structure, the encoder 2100 includes a receiver 2101, a transmitter 2102 and one or more processors 2103, the receiver 2101 is configured to receive a picture, the transmitter 2102 is configured for outputting a bitstream, and the one or more processors 2103 are configured to perform the foregoing method 1700 and any one of the related embodiments.

An embodiment of the present application discloses a computer program product comprising computer executable instructions that, when executed on a computing system, cause the computing system to execute a method according to any one of the forgoing embodiments.

An embodiment of the present application discloses a computer program stored on a storage medium, wherein computer program comprises computer executable instructions that, when executed on a computer or a processor, cause the computer or the processor to execute any one of the methods 1600 or 1700, or any one of the related embodiments.

An embodiment of the present application discloses a computer-readable storage medium comprising computer executable instructions that, when executed on a computer or a processor, cause the computer or the processor to execute a method according to method 1600 or any one of the related embodiments.

An embodiment of the present application discloses a computer-readable storage medium comprising computer executable instructions that, when executed on a computer or a processor, cause the computer or the processor to execute a method according to method 1700 or any one of the related embodiments.

An embodiment of the present inveniton disclose a decoder includes function units corresponding to the foregoing method operations 1610 to 1660, for example, the decoder includes a first obtaining unit for implementing the operation 1610, and a second obtaining unit for implementing the operation 1620, a sigma tensor obtaining unit for for implementing the operation 1630, a sigma quantization unit for implementing the operation 1640, a entropy decoding unit for implementing the operation 1650, and a decoder skip unit for implementing the operation 1660.

An embodiment of the present inveniton disclose an encoder includes function units corresponding to the foregoing method operations 1710 to 1750, for example, the encoder includes a first obtaining unit for implementing the operation 1710, a sigma tensor obtaining unit for for implementing the operation 1720, a sigma quantization unit for implementing the operation 1730, an encoder skip unit for implementing the operation 1740, and a a entropy encoding unit for implementing the operation 1750.

For the purposes of this document, the following terms and definitions apply.

### Padding Layer

padding layer is denoted as Padd(Hᵢₙ, Wᵢₙ, d, s_{d}), where Hᵢₙ, Wᵢₙ are height and width of tensor—input to Analysis transform, s_{d} is stride of proceeding convolution, d is depth of convolution layer in deep learnable encoder. Padding layer receives tensor of size [C, h_{d-1}, w_{d-1}] and outputs tensor of size [C, s_{d}h_{d}, s_{d}w_{d}], where h_{d}=ceil(h_{d-1}/s_{d}); w_{d}=ceil(w_{d-1}/s_{d}), h₀=Hᵢₙ, w₀=Wᵢₙ. By default padding is performed by replication. Different model of padding can be specified (for example, padding by zeros).

### Cropping Layer

cropping layer is denoted as Crop(Hᵢₙ, Wᵢₙ, d, s_{d}), where Hᵢₙ, Wᵢₙ are height and width of tensor-output to Synthesis transform, s_{d} is stride of proceeding transposed convolution, d is depth of convolution layer in deep learnable reconstruction process. Cropping layer receives tensor of size [C, s_{d}h_{d}, s_{d}w_{d}] and outputs tensor of size [C, h_{d-1}, w_{d-1}], where h_{d}=ceil(h_{d-1}/s_{d}); w_{d}=ceil(w_{d-1}/s_{d}), h₀=Hᵢₙ, w₀=Wᵢₙ Padding is performed by discarding redundant elements.

### Convolution Layer

two-dimensional convolution is denoted as CONV (Kᵥₑᵣ×Kₕₒᵣ, Cᵢₙ, Cₒᵤₜ, s↓). The convolution layer receives a tensor of size [Cᵢₙ, hᵢₙ, wᵢₙ] and outputs a tensor of size [Cₒᵤₜ, hₒᵤₜ, wₒᵤₜ], where hᵢₙ=s·hₒᵤₜ; wᵢₙ=s·wₒᵤₜ, factor s is called stride. In absence of stride argument no spatial resolution change is performed.

### Transposed Convolution

transposed convolution is denoted as CONV⁻¹(Kᵥₑᵣ×Kₕₒᵣ, Cᵢₙ, Cₒᵤₜ, s↑). The transposed convolution process receives a tensor of size [Cᵢₙ, hᵢₙ, wᵢₙ] and outputs tensor of size [Cₒᵤₜ, hₒᵤₜ, wₒᵤₜ], where hₒᵤₜ=s·hᵢₙ; wₒᵤₜ=s·wᵢₙ, factor s is called stride.

### Quantized Convolution

two-dimensional quantized convolution is denoted as qCONV(Kᵥₑᵣ×Kₕₒᵣ, Cᵢₙ, Cₒᵤₜ, s↓, d, p). Convolution process receives an integer tensor of size [Cᵢₙ, hᵢₙ, wᵢₙ] and outputs an integer tensor of size [Cₒᵤₜ, hₒᵤₜ, wₒᵤₜ], where hᵢₙ=s·hₒᵤₜ; wᵢₙ=s·wₒᵤₜ, factor s is called stride. In absence of stride argument it supposed to be equal to 1, no spatial resolution change is performed. The parameter d is non-negative integer number, which defines maximum magnitude of input tensor element after clipping. The tensor p[Cₒᵤₜ] contains de-scaling shifts for each channel of output tensor.

### Quantized Transposed Convolution

two-dimensional quantized transposed convolution is denoted as qCONV⁻¹(Kᵥₑᵣ×Kₕₒᵣ, Cᵢₙ, Cₒᵤₜ, s↑, d, p). Convolution process receives an 16-bit integer tensor of size [Cᵢₙ, hᵢₙ, wᵢₙ] and outputs integer tensor of size [Cₒᵤₜ, hₒᵤₜ, wₒᵤₜ], hₒᵤₜ=s·hᵢₙ; wₒᵤₜ=s·wᵢₙ, factor s is called stride. The parameter d is non-negative integer number, which defines maximum magnitude of input tensor element after clipping. The tensor p[Cₒᵤₜ] contains de-scaling shifts for each channel of the output tensor.

### Pixel Shuffle Layer

pixel shuffle layer, also known as sub-pixel convolution, is denoted as PixelShuffle(s), where s>1 is the upscale factor. This layer rearranges elements in a tensor input of shape [Cᵢₙ, hᵢₙ, wᵢₙ] to a tensor output of shape [Cₒᵤₜ, hₒᵤₜ, wₒᵤₜ], where hₒᵤₜ=s·hᵢₙ; wₒᵤₜ=s·wᵢₙ; Cₒᵤₜ=Cᵢₙ/s².

### Residual Activation Unit

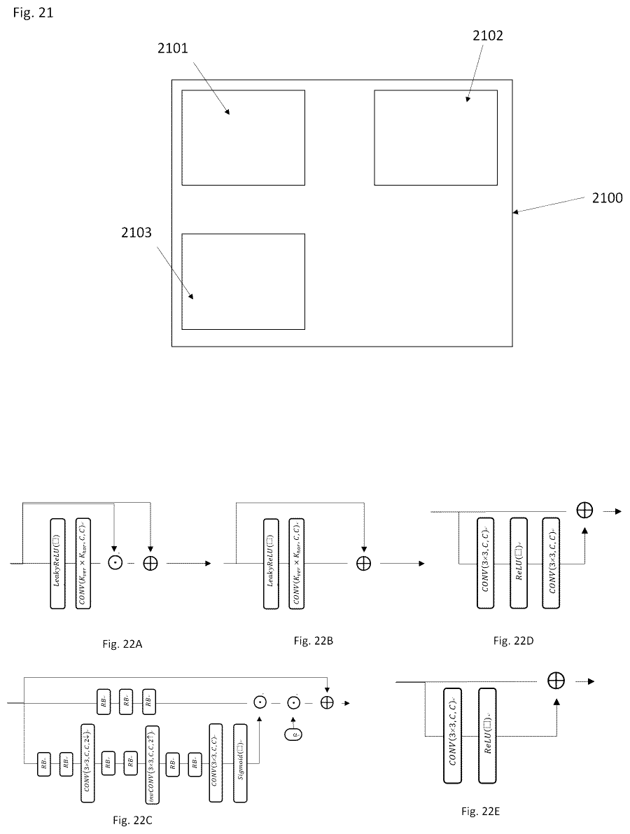

Residual activation unit is denoted as ResAU(Kᵥₑᵣ×Kₕₒᵣ). This layer receives tensor the tensor of size [C, hₖ, wₖ] and outputs tensor of same size after performing the sequence of operations depicted in FIG. 22A. Here ⊙ is element-wise multiplication and @ is addition of same size tensors.

### Residual Activation

Residual activation is denoted as ResA(Kᵥₑᵣ×Kₕₒᵣ). This layer receives tensor of size [C, hₖ, wₖ] and outputs tensor of same size after performing the sequence of operations depicted in FIG. 22B. Here ⊕ is addition of same size tensors.

### Residual Non-Local Attention Block

Residual non-local attention block is denoted as RNAB(∝). This layer receives tensor the tensor of size [C, hₖ, wₖ] and outputs tensor of same size after performing the sequence of operations depicted in FIG. 22C. Here ⊙ is element-wise multiplication and ⊕ is addition of same size tensors. Multiplier ∝ controls the strength of modification RNAB introduces. With ∝=0 all operations in RNAB introduces are essentially by-passed.

### Residual Block

Residual block is denoted as RB. This layer receives a tensor of size [C, hₖ, wₖ] and outputs a tensor of same size after performing the sequence of operations depicted in FIG. 22D.

### Lightweight Residual Block

Lightweight residual block is denoted as LRB. This layer receives a tensor of size [C, hₖ, wₖ] and outputs a tensor of same size after performing the sequence of operations depicted in FIG. 22E.

### Rectified Linear Unit

Rectified linear unit is denoted as ReLU( ). This the element-wise function

$$R e L U ( x ) = \{ \begin{matrix}x , & if x \geq 0 , \\ 0 , & otherwise .\end{matrix}$$

### Leaky Rectified Linear Unit

Leaky rectified linear unit is denoted as LeakyReLU( ). This the element-wise function

$$LeakyReLU ( x ) = \{ \begin{matrix}x , & if x \geq 0 , \\ negative\_slope \cdot x , & otherwise ,\end{matrix}$$

negative_slope=0.01.

opIdx is an identificator for operation point, 0 means “base” operation point, 1 means “high” operation point.

### Abs Operation

abs operation is denoted as ABS( ). This the element-wise function

$$ABS ( x ) = abs ( x ) = \vert x \vert .$$

### Mathematical Operators

The mathematical operators used in this application are similar to those used in the C programming language. However, the results of integer division and arithmetic shift operations are defined more precisely, and additional operations are defined, such as exponentiation and real-valued division. Numbering and counting conventions generally begin from 0, e.g., “the first” is equivalent to the 0-th, “the second” is equivalent to the 1-th, etc.

### Arithmetic Operators

The following arithmetic operators are defined as follows:
+ Addition
− Subtraction (as a two-argument operator) or negation (as a unary prefix operator)
* Multiplication, including matrix multiplication
x^{y} Exponentiation. Specifies x to the power of y. In other contexts, such notation is used for superscripting not intended for interpretation as exponentiation.
/ Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.

$$\frac{x}{y}$$

Used to denote division in mathematical equations where no truncation or rounding is intended.

$${\sum }_{i = x}^{y} f ( i )$$

The summation of f(i) with i taking all integer values from x up to and including y.
x % y Modulus. Remainder of x divided by y, defined only for integers x and y with x>=0 and y>0.

### Logical Operators

The following logical operators are defined as follows:
x && y Boolean logical “and” of x and y
x∥y Boolean logical “or” of x and y
! Boolean logical “not”
x?y: z If x is TRUE or not equal to 0, evaluates to the value of y; otherwise, evaluates to the value of z.

### Relational Operators

The following relational operators are defined as follows:
> Greater than
>= Greater than or equal to
< Less than
<= Less than or equal to
== Equal to
!= Not equal to

When a relational operator is applied to a syntax element or variable that has been assigned the value “na” (not applicable), the value “na” is treated as a distinct value for the syntax element or variable. The value “na” is considered not to be equal to any other value.

### Bit-Wise Operators

The following bit-wise operators are defined as follows:
& Bit-wise “and”. When operating on integer arguments, operates on a two's complement representation of the integer value. When operating on a binary argument that contains fewer bits than another argument, the shorter argument is extended by adding more significant bits equal to 0.
   | Bit-wise “or”. When operating on integer arguments, operates on a two's complement representation of the integer value. When operating on a binary argument that contains fewer bits than another argument, the shorter argument is extended by adding more significant bits equal to 0.
\hat{ }A Bit-wise “exclusive or”. When operating on integer arguments, operates on a two's complement representation of the integer value. When operating on a binary argument that contains fewer bits than another argument, the shorter argument is extended by adding more significant bits equal to 0.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### Assignment Operators

The following arithmetic operators are defined as follows:
= Assignment operator
++ Increment, i.e., x++ is equivalent to x=x+1; when used in an array index, evaluates to the value of the variable prior to the increment operation.
−− Decrement, i.e., x−− is equivalent to x=x−1; when used in an array index, evaluates to the value of the variable prior to the decrement operation.
+= Increment by amount specified, i.e., x+=3 is equivalent to x=x+3, and x+=(−3) is equivalent to x=x+(−3).
−= Decrement by amount specified, i.e., x−=3 is equivalent to x=x−3, and x−=(−3) is equivalent to x=x−(−3).

### Range Notation

The following notation is used to specify a range of values:
x=y . . . z x takes on integer values starting from y to z, inclusive, with x, y, and z being integer numbers and z being greater than y.

### Mathematical Functions

The following mathematical functions are defined:

$$Abs ( x ) = \{ \begin{matrix}x & ; & x >= 0 \\ - x & ; & x < 0\end{matrix}$$

A sin(x) the trigonometric inverse sine function, operating on an argument x that is in the range of −1.0 to 1.0, inclusive, with an output value in the range of −π÷2 to π÷2, inclusive, in units of radians
Atan(x) the trigonometric inverse tangent function, operating on an argument x, with an output value in the range of −π÷2 to π÷2, inclusive, in units of radians

$$A tan 2 ( y , x ) = \{ \begin{matrix}A tan ( \frac{y}{x} ) & ; & x > 0 \\ A tan ( \frac{y}{x} ) + π & ; & x < 0 \&\& y >= 0 \\ A tan ( \frac{y}{x} ) - π & ; & x < 0 \&\& y < 0 \\ + \frac{π}{2} & ; & x == 0 \&\& y >= 0 \\ - \frac{π}{2} & ; & otherwise\end{matrix}$$

Ceil(x) the smallest integer greater than or equal to x.

$$Clip {1}_{Y} ( x ) = Clip 3 ( 0 , ( 1 << {BitDepth}_{Y} ) - 1 , x )$$

$$Clip {1}_{C} ( x ) = Clip 3 ( 0 , ( 1 << {BitDepth}_{C} ) - 1 , x )$$

$$Clip 3 ( x , y , z ) = \{ \begin{matrix}x & ; & z < x \\ y & ; & z > y \\ z & ; & otherwise\end{matrix}$$

Cos(x) the trigonometric cosine function operating on an argument x in units of radians.
Floor(x) the largest integer less than or equal to x.

$$GetCurrMsb ( a , b , c , d ) = \{ \begin{matrix}c + d & ; & b - a >= d / 2 \\ c - d & ; & a - b > d / 2 \\ c & ; & otherwise\end{matrix}$$

Ln(x) the natural logarithm of x (the base-e logarithm, where e is the natural logarithm base constant 2.718 281 828 . . . ).
Log 2(x) the base-2 logarithm of x.
Log 10(x) the base-10 logarithm of x.

$$\begin{matrix}Min ( x , y ) = \{ \begin{matrix}x & ; & x <= y \\ y & ; & x > y\end{matrix} \\ Max ( x , y ) = \{ \begin{matrix}x & ; & x >= y \\ y & ; & x < y\end{matrix} \\ Round ( x ) = Sign ( x ) * Floor ( Abs ( x ) + 0 \text{.5} ) \\ Sign ( x ) = \{ \begin{matrix}1 & ; & x > 0 \\ 0 & ; & x == 0 \\ - 1 & ; & x < 0\end{matrix}\end{matrix}$$

Sin(x) the trigonometric sine function operating on an argument x in units of radians

$$\begin{matrix}Sqrt ( x ) = \sqrt{x} \\ Swap ( x , y ) = ( y , x )\end{matrix}$$

Tan(x) the trigonometric tangent function operating on an argument x in units of radians

### Order of Operation Precedence

When an order of precedence in an expression is not indicated explicitly by use of parentheses, the following rules apply:
Operations of a higher precedence are evaluated before any operation of a lower precedence.
Operations of the same precedence are evaluated sequentially from left to right.

The table below specifies the precedence of operations from highest to lowest; a higher position in the table indicates a higher precedence.

For those operators that are also used in the C programming language, the order of precedence used in this Specification is the same as used in the C programming language.

TABLE
Operation precedence from highest (at top of table) to lowest
(at bottom of table)

operations (with operands x, y, and z)
“x++”, “x− −”
“!x”, “−x” (as a unary prefix operator)
x^{y}
$“ x * y ” , “ x / y ” , “ x \div y ” , “ \frac{x}{y} ” , “ x \% y ”$
“x + y”, “x − y” (as a two-argument operator),
$“ {{\sum }_{i = x}}^{y} f ( i ) ”$
“x << ”, “x >> y”
“x < y”, “x <= y”, “x > y”, “x >= y”
“x = = y”, “x != y”
“x & y”
“x | y”
“x && y”
“x | | y”
“x ? y : z”
“x .. y”
“x = y”, “x += y”, “x −= y”

### Text Description of Logical Operations

In the text, a statement of logical operations as would be described mathematically in the following form:

```
  if( condition 0 )
    statement 0
  else if( condition 1 )
    statement 1
  ...
  else /* informative remark on remaining condition */
    statement n
may be described in the following manner:
    ... as follows / ... the following applies:
    - If condition 0, statement 0
    - Otherwise, if condition 1, statement 1
    - ...
    - Otherwise (informative remark on remaining condition), statement n
```

Each “If . . . Otherwise, if . . . Otherwise, . . . ” statement in the text is introduced with “ . . . as follows” or “ . . . the following applies” immediately followed by “If . . . ”. The last condition of the “If . . . Otherwise, if . . . Otherwise, . . . ” is always an “Otherwise, . . . ”. Interleaved “If . . . Otherwise, if . . . Otherwise, . . . ” statements can be identified by matching “ . . . as follows” or “ . . . the following applies” with the ending “Otherwise, . . . ”.

In the text, a statement of logical operations as would be described mathematically in the following form:

```
  if( condition 0a && condition 0b )
    statement 0
  else if( condition 1a | | condition 1b )
    statement 1
  ...
  else
    statement n
may be described in the following manner:
  ... as follows / ... the following applies:
```

| | |
|---|---|
| - | If all of the following conditions are true, statement 0: |
| | - condition 0a |
| | - condition 0b |
| - | Otherwise, if one or more of the following conditions are true, statement 1: |
| | - condition 1a |
| | - condition 1b |
| - | ... |
| - | Otherwise, statement n |

In the text, a statement of logical operations as would be described mathematically in the following form:

```
  if( condition 0 )
    statement 0
  if( condition 1 )
    statement 1
may be described in the following manner:
    When condition 0, statement 0
    When condition 1, statement 1
```

Although embodiments of the application have been primarily described based on video coding, it should be noted that embodiments of the coding system 10, encoder 20 and decoder 30 (and correspondingly the system 10) and the other embodiments described herein may also be configured for still picture processing or coding, i.e. the processing or coding of an individual picture independent of any preceding or consecutive picture as in video coding. In general only inter-prediction units 244 (encoder) and 344 (decoder) may not be available in case the picture processing coding is limited to a single picture 17. All other functionalities (also referred to as tools or technologies) of the video encoder 20 and video decoder 30 may equally be used for still picture processing, e.g. residual calculation 204/304, transform 206, quantization 208, inverse quantization 210/310, (inverse) transform 212/312, partitioning 262/362, intra-prediction 254/354, and/or loop filtering 220, 320, and entropy coding 270 and entropy decoding 304. In general, the embodiments of the present disclosure may be also applied to other source signals such as an audio signal or the like.

Embodiments, e.g. of the encoder 20 and the decoder 30, and functions described herein, e.g. with reference to the encoder 20 and the decoder 30, may be implemented in hardware, software, firmware, or any combination thereof. If implemented in software, the functions may be stored on a computer-readable medium or transmitted over communication media as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limiting, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

1. A method for decoding a bitstream, comprising:
obtaining a first bitstream;
obtaining a second bitstream comprising hyper prior information of the first bitstream;
obtaining a first sigma tensor based on the second bitstream, wherein the first sigma tensor comprises sigma values that are variance values or standard deviation values, and the variance values or the standard deviation values are related with probability distribution information of the first bitstream;
obtaining a sigma index for a first sigma value of the first sigma tensor based on a quantization process, wherein the sigma index indicates one of probability distributions in a probability distribution table;
entropy decoding the first bitstream based on the sigma index to obtain a sequence of decoded symbols; and
processing the sequence of decoded symbols based on a skip mask to obtain a residual tensor used to obtain a reconstructed image.

2. The method according to claim 1, wherein the quantization process quantizes a sigma value of the first sigma tensor into a sigma value among discrete values in a range from a minimum sigma value to a maximum sigma value.

3. The method according to claim 1, wherein a sigma number N_{σ} of the quantization process is set as a power of 2, and the N_{σ} indicates a number of the probability distributions in the probability distribution table.

4. The method according to claim 2, wherein a sigma number N_{σ} of the quantization process is set as a power of 2, and the N_{σ} indicates a number of the discrete values in the range.

5. The method according to claim 4, wherein the N_{σ} of the quantization process is set equal to 32.

6. The method according to claim 2, wherein the minimum sigma value of the quantization process is set equal to 0.11.

7. The method according to claim 2, wherein the maximum sigma value of the quantization process is set equal to 100.

8. The method according to claim 1, wherein obtaining the sigma index for the first sigma value of the first sigma tensor comprises:
obtaining the sigma index based on the following:
$$sigma\_Idx = clip ( ( {I}_{σ}^{″} + {2}^{s i g m a P r e c i s i o n - 1} ) ≫ sigmaPrecision , 0 , {N}_{σ} - 1 ) \underline{;}$$
wherein the sigma_idx represents the sigma index, the I_{σ}″ represents the first sigma value in a logarithmic domain, the sigmaPrecision is equal to 7, and the N_{σ} is equal to 32.

9. The method according to claim 1, wherein obtaining the sigma index for the first sigma value of the first sigma tensor comprises:
obtaining the sigma index based on the following:
$$sigma\_Idx = i , {b}_{i} \leq {σ}^{″} < {b}_{i + 1}$$
$${b}_{i} = exp ( ( ln ( {σ}_{max} ) - ln ( {σ}_{min} ) ) \cdot ( i + 0 \text{.5} ) / ( {N}_{σ} - 1 ) + ln ( {σ}_{min} ) ) i = 0 , … , {N}_{σ} - 1 \underline{;}$$
wherein the sigma_idx represents the sigma index, the σ″ represents the first sigma value in a linear domain, the σₘᵢₙ is the minimum sigma value, the σₘₐₓ is the maximum sigma value, the N_{σ} is the sigma number, and the N_{σ} is equal to 32.

10. A method for encoding a bitstream, comprising:
obtaining hyper prior information of an image data;
obtaining a first sigma tensor based on the hyper prior information, wherein the first sigma tensor comprises sigma values that are variance values or standard deviation values, wherein the variance values or the standard deviation values are related with probability distribution information of the image data;
obtaining a sigma index for a first sigma value of the first sigma tensor based on a quantization process, wherein the sigma index indicates one of probability distributions in a probability distribution table;
processing a sequence of symbols based on a skip mask to obtain a sequence of encoded symbols; and
entropy encoding the sequence of encoded symbols based on the sigma index to obtain a first bitstream.

11. The method according to claim 10, wherein the quantization process quantizes a sigma value of the first sigma tensor into a sigma value among discrete values in a sigma range from a minimum sigma value to a maximum sigma value.

12. The method according to claim 10, wherein a sigma number N_{σ} of the quantization process is set as a power of 2, wherein the N_{σ} indicates a number of the probability distributions in the probability distribution table.

13. The method according to claim 11, wherein a sigma number N_{σ} of the quantization process is set as a power of 2, wherein the N_{σ} indicates a number of the discrete values in the sigma range.

14. The method according to claim 13, wherein the N_{σ} of the quantization process is set equal to 32.

15. The method according to claim 11, wherein obtaining, the sigma index for the first sigma value of the first sigma tensor comprises:
obtaining the sigma index based on the following:
$$sigma\_Idx = clip ( ( {I}_{σ}^{″} + {2}^{s i g m a P r e c i s i o n - 1} ) ≫ sigmaPrecision , 0 , {N}_{σ} - 1 ) \underline{;}$$
wherein the sigma_idx represents the sigma index, the I_{σ}″ represents the first sigma value in a logarithmic domain, the sigmaPrecision is equal to 7, and the N_{σ} is equal to 32.

16. The method according to claim 11, wherein obtaining the sigma index for the first sigma value of the first sigma tensor comprises:
obtaining the sigma index based on the following:
$$sigma\_Idx = i , {b}_{i} \leq {σ}^{″} < {b}_{i + 1}$$
$${b}_{i} = exp ( ( ln ( {σ}_{max} ) - ln ( {σ}_{min} ) ) \cdot ( i + 0 \text{.5} ) / ( {N}_{σ} - 1 ) + ln ( {σ}_{min} ) ) i = 0 , … , {N}_{σ} - 1 \underline{;}$$
wherein the sigma_idx represents the sigma index, the σ″ represents the first sigma value in a linear domain, the σₘᵢₙ is the minimum sigma value, the σₘₐₓ is the maximum sigma value, the N_{σ} is the sigma number, and the N_{σ} is equal to 32.

17. A decoder for processing a bitstream, comprising:
one or more processors; and
a storage medium configured to store computer executable instructions, which when executed by the one or more processors, cause the decoder to perform operations comprising:
obtaining a first bitstream;
obtaining a second bitstream comprising hyper prior information of the first bitstream;
obtaining a first sigma tensor based on the second bitstream, wherein the first sigma tensor comprises sigma values that are variance values or standard deviation values, wherein the variance values or the standard deviation values are related with probability distribution information of the first bitstream;
obtaining a sigma index for a first sigma value of the first sigma tensor based on a quantization process, wherein the sigma index indicates one of probability distributions in a probability distribution table;
entropy decoding the first bitstream based on the sigma index to obtain a sequence of decoded symbols; and
processing the sequence of decoded symbols based on a skip mask to obtain a residual tensor used to obtain a reconstructed image.

18. The decoder according to claim 17, wherein the quantization process quantizes a sigma value of the first sigma tensor into a sigma value among discrete values in a range from a minimum sigma value to a maximum sigma value.

19. The decoder according to claim 18, wherein a sigma number N_{σ} of the quantization process is set as a power of 2, and the N_{σ} indicates the number of the discrete values in the range.

20. The decoder according to claim 19, wherein the N_{σ} of the quantization process is set equal to 32.
